(19) United States
(12) Patent Application Publication
(10) Pub. No.: US 2014/0226080 A1
(43) Pub. Date: Aug. 14, 2014

(54) DISPLAY UNIT AND TELEVISION RECEIVING APPARATUS

(71) Applicants: Masatoshi Tomomasa, Osaka (JP); Motomitsu Itoh, Osaka (JP)

(72) Inventors: Masatoshi Tomomasa, Osaka (JP); Motomitsu Itoh, Osaka (JP)

(73) Assignee: SHARP KABUSHIKI KAISHA, Osaka (JP)

(21) Appl. No.: 14/342,509

(22) PCT Filed: Sep. 3, 2012
(86) PCT No.: PCT/JP2012/072332

§ 371 Date: Mar. 3, 2014

(30) Foreign Application Priority Data
Sep. 6, 2011 (JP) 2011-194030

(51) Int. Cl. F21V 8/00; H04N 5/645

(52) U.S. Cl. CPC G02B 6/0081; G02B 6/0085; H04N 5/645
USPC 348/794; 349/58

(57) ABSTRACT

A liquid crystal display unit (10) includes: an LED (17); a heat dissipating member (19) to which the LED (17) is attached; a liquid crystal panel (11) that performs display using light of the LED (17); a flexible substrate (22) connected to an edge of the liquid crystal panel (11); a light guide plate (16) disposed on a side of the liquid crystal panel (11) opposite to a display surface (11c) of the liquid crystal panel (11), the light guide plate being disposed such that an end face of the light guide plate faces the LED (17); holding members (HM) that hold and sandwich the liquid crystal panel (11) and the light guide plate (16) from the side of the display surface (11c) and from the side opposite thereto; and a light-shielding member (26) disposed on the heat dissipating member (19), the light-shielding member being interposed between the liquid crystal panel (11) and the LED (17) for preventing light from the LED (17) from directly entering the liquid crystal panel (11), the light shielding part (26) being configured such that a flexible substrate passage (FS) through which the flexible substrate (22) passes is formed between the light-shielding member (26) and a frame (13), of the holding members (HM), that is disposed on the side of the display surface (11c).

### TECHNICAL FIELD

The present invention relates to a display device and a television receiver.

### BACKGROUND ART

In recent years, flat panel display devices that use flat panel display elements such as liquid crystal panels and plasma display panels are increasingly used as display elements for image display devices such as television receivers instead of conventional cathode-ray tube displays, allowing image display devices to be made thinner. In the liquid crystal display device, a liquid crystal panel used therein does not emit light, and therefore, it is necessary to separately provide a backlight device as an illumination device. The backlight devices are largely categorized into a direct-lighting type and an edge-lighting type depending on the mechanism thereof. In order to make the liquid crystal display device even thinner, it is preferable to use the edge-lighting type backlight device, and a known example thereof is disclosed in Patent Document 1 below.

### RELATED ART DOCUMENT

### Patent Document

Patent Document 1: Japanese Patent Application Laid-Open Publication No. 2011-82176

### Problems to be Solved by the Invention

The liquid crystal display device disclosed in Patent Document 1 above has a configuration in which a liquid crystal panel is sandwiched by a panel pressing member on the front side and a panel receiving member on the rear side. In order to satisfy demands for a lower manufacturing cost and a further reduction in thickness, for example, elimination of the panel receiving member on the rear side is considered, for example. However, the panel receiving member is interposed between the light source and the liquid crystal panel, and has the function of blocking light from the light source from directly entering an edge of the liquid crystal panel, and therefore, if the panel receiving member is simply eliminated, light from the light source would directly enter the edge of the liquid crystal panel, that is, a light leakage would occur.

### SUMMARY OF THE INVENTION

The present invention was completed in view of the above-mentioned situation, and an object thereof is to prevent light leakage.

### Means for Solving the Problems

A display device of the present invention includes: a light source; a light source attachment member to which the light source is attached; a display panel that conducts display using light from the light source; a flexible substrate that is connected to an edge of the display panel; a light guide plate disposed on a side of the display panel opposite to a display surface thereof, the light guide plate being disposed such that an end face thereof faces the light source; a holding member that is constituted of a pair of holding parts that sandwich the display panel and the light guide plate from a display surface side of the display device and a side opposite thereto, the holding member housing the light source, the light source attachment member, and the flexible substrate between the pair of holding parts; and a light-shielding member provided in the light source attachment member, the light-shielding member blocking light from the light source from directly entering the display panel, the light-shielding member being configured such that a flexible substrate passage through which the flexible substrate passes is formed between the light-shielding member and the holding part, of the pair of holding parts, that is disposed on the display surface side.

With this configuration, light emitted from the light source is guided into the display panel after entering the end face of the light guide plate that faces the light source, and an image is displayed on the display panel using this light. The display panel and the light guide plate are stacked and sandwiched by a pair of holding parts constituting the holding member from the display surface side and the opposite side thereto, and a panel receiving member is not interposed between the light guide plate and the display panel unlike the conventional configuration. Therefore, light from the light source would directly enter an edge of the display panel without passing through the light guide plate. However, because the light source attachment member is provided with a light-shielding member that is interposed between the display panel and light source, light from the light source can be prevented from directly entering the edge of the display panel without passing through the light guide plate by the light-shielding member. As a result, light leakage can be prevented. By the light-shielding member being provided in the light source attachment member, a flexible substrate passage through which the flexible substrate passes can be formed between the light-shielding member and a holding member, of the pair of holding parts, that is disposed on the display surface side. If the light-shielding member that is interposed between the light source and the light guide plate is provided in the holding part disposed on the display surface side, the flexible substrate could not pass through due to the structural constraint, and if the light-shielding member is configured to avoid such a problem, it would become impossible to shield light in a position overlapping the flexible substrate. On the other hand, with the above-mentioned configuration, it is possible to achieve the light-shielding function of the light-shielding member even in a position overlapping the flexible substrate while allowing the flexible substrate to pass through, and therefore, light leakage caused by the flexible substrate can also be prevented.

As embodiments of the present invention, the following configurations are preferred.

(1) A plurality of the flexible substrates are arranged at intervals in a direction along the edge of the display panel, and the light-shielding member is disposed so as to extend across overlapping sections that overlap the flexible substrates in a plan view and non-overlapping sections that do not overlap the flexible substrates in a plan view. With this configuration, in both of the overlapping sections and the non-overlapping sections, light from the light source can be prevented from directly entering the edge of the display panel without passing through the light guide plate by the light-shielding member, and in addition, at borders between the overlapping sections and the non-overlapping sections, light from the light source can be shielded by the light-shielding member disposed so as to extend over the two regions. Thus, light leakage can be prevented more reliably.

(2) The light-shielding member has a heat-dissipation-accelerating portion in a portion thereof that is disposed in the non-overlapping section, the heat-dissipation-accelerating portion abutting on the holding part, of the pair of holding parts, that is disposed on the display surface side. With this configuration, heat generated by the light source when the light source is lit is transferred from the light source to the light source attachment member, and then further to the holding part disposed on the display surface side. On the holding part, the heat-dissipation-accelerating portion of the light-shielding member abuts. Therefore, heat is dissipated efficiently using the thermal capacity of the holding part. The heat-dissipation-accelerating portion is disposed in the non-overlapping section that does not overlap the flexible substrate in a plan view, and therefore, the heat-dissipation-accelerating portion does not block the flexible substrate passage through which the flexible substrate passes.

(3) The light-shielding member has a light guide plate supporting portion at least in a portion thereof that is disposed in the non-overlapping section, the light guide plate supporting portion abutting on a surface of the light guide plate that faces the display panel. In this configuration, the light guide plate supporting portion formed in the light-shielding member abuts on the light guide plate, which blocks the gap between the light source and the display panel, and therefore, the light-shielding function can be further improved. The light guide plate supporting portion is formed at least in a portion of the light-shielding member that is disposed in the non-overlapping section, or in other words, in a position that overlaps the heat-dissipation-accelerating portion in a plan view, and therefore, the light guide plate supporting portion can press firmly the light guide plate together with the heat-dissipation-accelerating portion and the holding part disposed on the display surface side. As a result, the light guide plate can be accurately positioned with respect to the light source. Heat from the light source can be transferred not only to the holding part disposed on the display surface side, but also to the light guide plate, and therefore, the heat dissipation property is even more improved.

(4) At least one holding part of the pair of holding parts that is disposed on the display surface side is made of a metal. With this configuration, the holding part disposed on the display surface side has excellent heat conductivity, and therefore, heat from the light source, which is transferred through the heat-dissipation-accelerating portion, can be dissipated more efficiently. The rigidity of the holding part disposed on the display surface is made higher, which makes this configuration useful when the display device is made larger.

(5) The light-shielding member is disposed so as to extend over the edge of the display panel in an entire length thereof. With this configuration, light leakage to the display panel can be prevented more reliably.

(6) The light-shielding member has a light guide plate supporting portion that abuts on a surface of the light guide plate that faces the display panel. In this configuration, the light guide plate supporting portion formed in the light-shielding member abuts on the light guide plate, which blocks the gap between the light source and the display panel, and therefore, the light-shielding function can be further improved. Also, by supporting the light guide plate with the light guide plate supporting portion from the display panel side, the light guide plate can be positioned with respect to the light source.

(7) The light guide plate supporting portion abuts on an edge of the light guide plate that faces the light source. With this configuration, by having the light guide plate supporting portion support the edge of the light guide plate that faces the light source, a stable positional relationship between the light source and the end face of the light guide plate that faces the light source can be achieved. As a result, the incident efficiency of light that enters the light guide plate from the light source can be made stable.

(8) The display device further includes a light source substrate on which the light source is mounted, and the light source substrate is attached to the light source attachment member having the light-shielding member. In this configuration, unlike a configuration in which the light source substrate is used as the light source attachment member, and the light-shielding member is provided in the light source substrate, the light source substrate is not provided with the light-shielding member, and therefore, a commonly-available part can be used as the light source substrate instead of a specialized part. As a result, the cost of the light source substrate can be reduced, and the mounting of the light source can be made easier.

(9) The light source attachment member has a heat-dissipating section that extends along a plate surface of the holding part, of the pair of holding parts, that is disposed on a side of the display device opposite to the display surface side, the heat-dissipating section making surface-to-surface contact with the plate surface of the holding part disposed on the side opposite to the display surface. With this configuration, heat can be efficiently transferred to the holding part that is disposed on the side opposite to the display surface from the heat-dissipating section of the light source attachment member, and therefore, heat is less likely to be trapped in the display device.

(10) The light source attachment member has a light source attachment section to which the light source is attached, the light source attachment section facing the light guide plate, and one holding part, of the pair of holding parts, that is disposed on the display surface side has a protruding member that protrudes toward the heat-dissipating section, the protruding member being provided to attach the heat-dissipating section thereto. With this configuration, by attaching the heat-dissipating section to the protruding member, the light source attached to the light source attachment section is positioned with respect to the light guide plate.

(11) The display device further includes a printed board connected to an edge of flexible substrate on a side opposite to the edge connected to the display panel, and a substrate housing space that is connected to the flexible substrate passage and that can house the printed board therein is formed between the protruding member and the light source attachment section. With this configuration, the flexible substrate connected to the display panel passes through the flexible substrate passage, and is connected to the printed board that is housed in the substrate housing space that is connected to the flexible substrate passage.

(12) At least one holding part of the pair of holding parts that is disposed on the side opposite to the display surface side is made of a metal. With this configuration, the holding part disposed on the side opposite to the display surface has excellent heat conductivity, and therefore, heat from the light source, which is transferred through the heat dissipation section of the light source attachment member, can be dissipated more efficiently. The rigidity of the holding part disposed on the side opposite to the display surface is made higher, which makes this configuration useful when the display device is made larger.

(13) The display device further includes a heat-dissipating sheet member disposed so as to be continued to the light-shielding member and the display panel. With this configuration, heat generated by the light source when the light source is lit is transferred to the display panel through the heat-dissipating sheet member from the light-shielding member of the light source attachment member after being transferred from the light source to the light source attachment member. Therefore, the heat can be efficiently dissipated using the thermal capacity of the display panel.

### Effects of the Invention

According to the present invention, light leakage can be prevented.

### BRIEF DESCRIPTION OF THE DRAWINGS

FIG. 1 is an exploded perspective view that shows a schematic configuration of a television receiver and a liquid crystal display device according to Embodiment 1 of the present invention.

FIG. 2 is a rear view of the television receiver and the liquid crystal display device.

FIG. 3 is an exploded perspective view showing a schematic configuration of a liquid crystal display unit that constitutes a part of the liquid crystal display device.

FIG. 4 is a cross-sectional view of a configuration of a liquid crystal display unit (liquid crystal display device) along the shorter side direction.

FIG. 5 is a perspective view of an LED unit.

FIG. 6 is a partial plan view showing a longer side edge of the liquid crystal display unit without a frame.

FIG. 7 is a cross-sectional view (in an overlapping section) along the line vii-vii of FIG. 6.

FIG. 8 is a cross-sectional view (in a non-overlapping section) along the line viii-viii of FIG. 6.

FIG. 9 is a cross-sectional view along the line ix-ix of FIGS. 7 and 8.

FIG. 10 is a cross-sectional view along the line vii-vii of FIG. 5, showing a work procedure to assemble respective constituting members of the liquid crystal display unit that constitutes a part of the liquid crystal display device.

FIG. 11 is a cross-sectional view showing a cross-sectional configuration of a light-shielding member and a buffer member of Modification Example 1 of Embodiment 1 in the overlapping section.

FIG. 12 is a cross-sectional view showing a cross-sectional configuration of a light-shielding member and a buffer member of Modification Example 2 of Embodiment 1 in the non-overlapping section.

FIG. 13 is a cross-sectional view showing a cross-sectional configuration of a light-shielding member and a frame of Modification Example 3 of Embodiment 1 in the non-overlapping section.

FIG. 14 is a cross-sectional view showing a cross-sectional configuration of a light-shielding member, liquid crystal panel, and heat-dissipating sheet member of Embodiment 2 of the present invention in the overlapping section.

FIG. 15 is a cross-sectional view showing a cross-sectional configuration of the light-shielding member, liquid crystal panel, and heat-dissipating sheet member in the non-overlapping section.

FIG. 16 is a cross-sectional view showing a cross-sectional configuration of a light-shielding member and a frame of Embodiment 3 of the present invention in the overlapping section.

FIG. 17 is a cross-sectional view showing a cross-sectional configuration of the light-shielding member and the frame in the non-overlapping section.

FIG. 18 is a cross-sectional view showing a cross-sectional configuration of a light-shielding member and a frame of Embodiment 4 of the present invention.

FIG. 19 is a cross-sectional view showing a cross-sectional configuration of a light-shielding member, frame, and heat-insulating member of Embodiment 5 of the present invention in the non-overlapping section.

FIG. 20 is a cross-sectional view showing a cross-sectional configuration of a liquid crystal display device of Embodiment 6 of the present invention along the shorter side direction.

FIG. 21 is a cross-sectional view showing a cross-sectional configuration of a light-shielding member, insulating member, and flexible substrate of Embodiment 7 of the present invention in the overlapping section.

### DETAILED DESCRIPTION OF EMBODIMENTS

### Embodiment 1

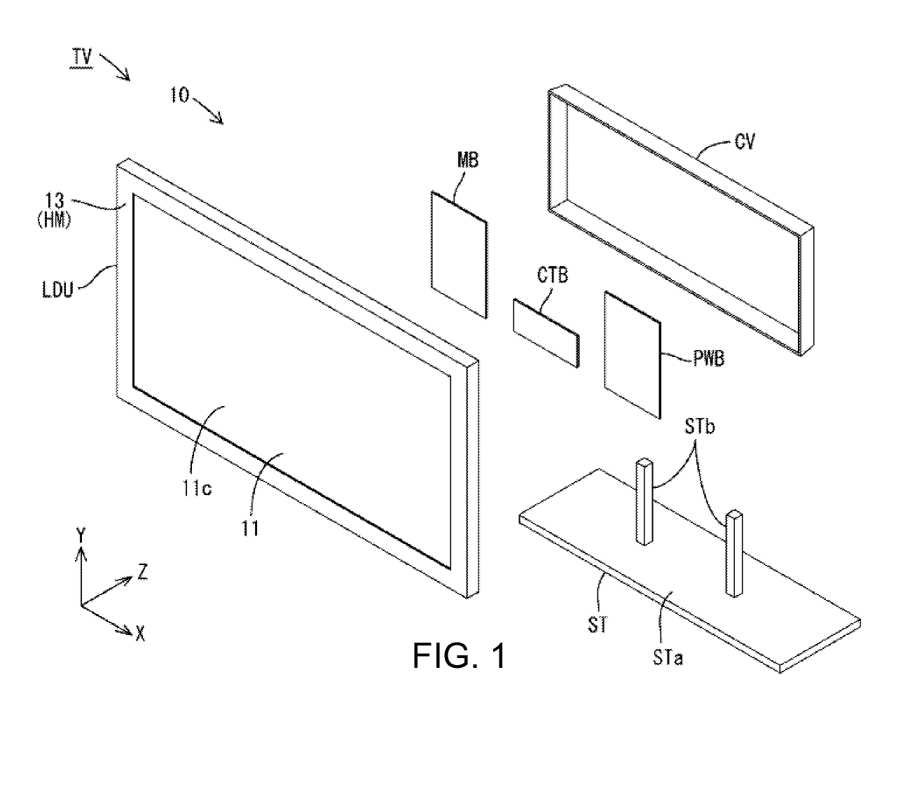

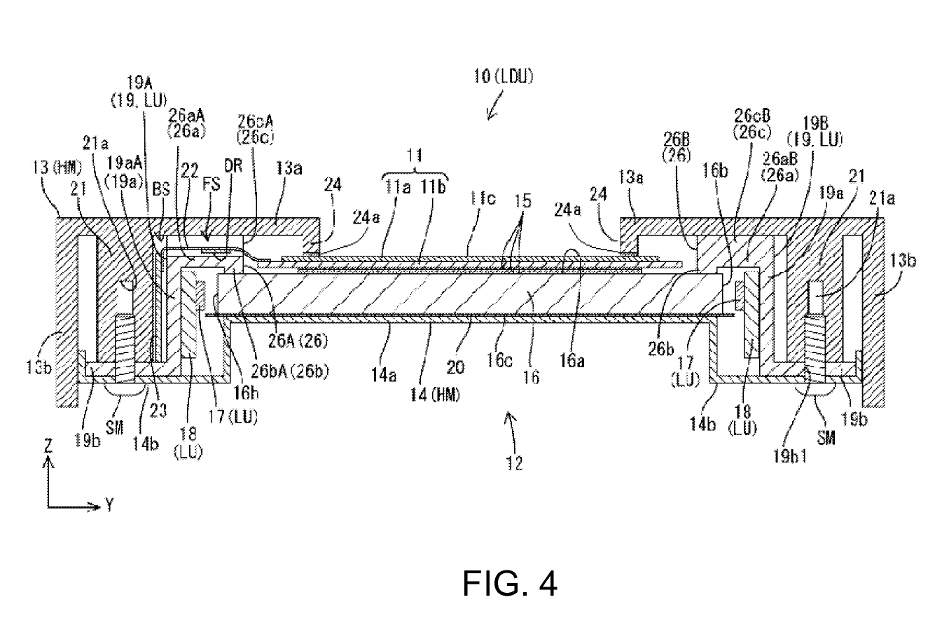

Embodiment 1 of the present invention will be described with reference to FIGS. 1 to 10. In the present embodiment, a liquid crystal display device 10 will be described as an example. The drawings indicate an X axis, a Y axis, and a Z axis in a portion of the drawings, and each of the axes indicates the same direction for the respective drawings. The upper side of FIG. 4 is the front side, and the lower side is the rear side.

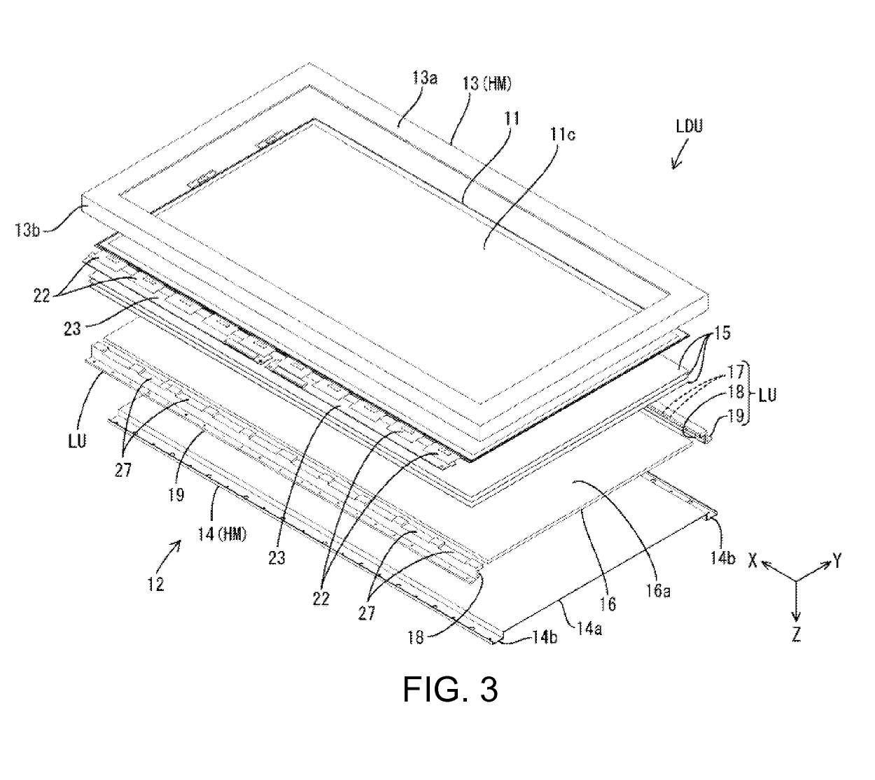

As shown in FIG. 1, a television receiver TV of the present embodiment includes: a liquid crystal display unit (display unit) LDU; various boards PWB, MB, and CTB that are attached to the back side (rear side) of the liquid crystal display unit LDU; a cover member CV attached to the rear side of the liquid crystal display unit LDU so as to cover the various boards PWB, MB, and CTB; and a stand ST. The television receiver TV is supported by the stand ST such that the display surface of the liquid crystal display unit LDU is parallel to the vertical direction (Y axis direction). The liquid crystal display device 10 of the present embodiment is obtained by removing at least the configuration for receiving television signals (such as a tuner part of the main board MB) from the television receiver TV having the above-mentioned configuration. As shown in FIG. 3, the liquid crystal display unit LDU is formed to be a horizontally-long quadrangle (rectangular shape) as a whole, and includes a liquid crystal panel 11 that is a display panel, and a backlight device (illumination device) 12 that is an external light source. The liquid crystal panel 11 and the backlight device 12 are held as one component by a frame (holding part disposed on a display surface 11c side) 13 and a chassis (holding part disposed on a side opposite to the display surface 11c) 14 that are exterior members constituting the exterior of the liquid crystal display device 10. The frame 13 and the chassis 14 constitute a holding member HM. The chassis 14 of the present embodiment constitutes the exterior member, a part of the holding member HM, and a part of the backlight device 12.

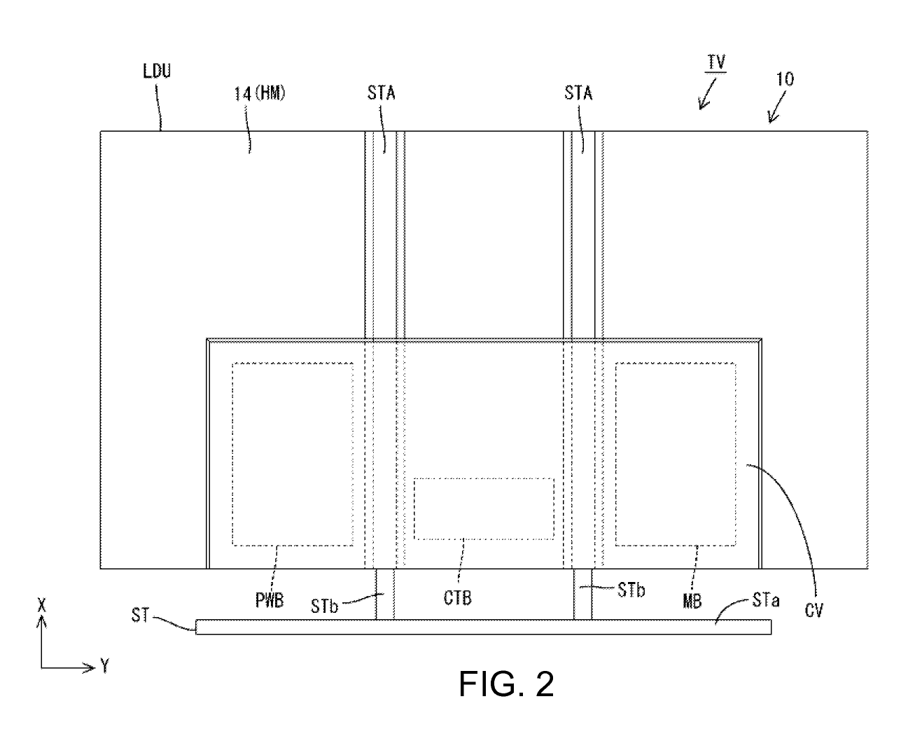

First, the configuration of the rear side of the liquid crystal display device 10 will be explained. As shown in FIG. 2, on the rear side of the chassis 14 that constitutes the rear exterior of the liquid crystal display device 10, a pair of stand attachment members STA extending along the Y axis direction is installed at two locations that are separated from each other along the X axis direction. The cross-sectional shape of these stand attachment members STA is a substantially channel shape that opens toward the chassis 14, and a pair of support columns STb of the stand ST is inserted into spaces formed between the stand attachment members STA and the chassis 14, respectively. Wiring members (such as electric wires) connected to LED substrates 18 of the backlight device 12 run through spaces inside of the respective stand attachment members STA. The stand ST is constituted of a base STa that is disposed in parallel with the X axis direction and the Z axis direction, and a pair of support columns STb standing on the base STa along the Y axis direction. The cover member CV is made of a synthetic resin, and is attached so as to cover about a half of the lower part of the rear side of the chassis 14 of FIG. 2, while extending across the pair of stand attachment members STA along the X axis direction. Between the cover member CV and the chassis 14, a component housing space is provided to house the components mentioned below such as various boards PWB, MB, and CTB.

As shown in FIG. 2, the various boards PWB, MB, and CTB include a power supply board PWB, a main board MB, and a control board CTB. The power supply board PWB is a power source for the liquid crystal display device 10, and can supply driving power to other boards MB and CTB, LEDs 17 of the backlight device 12, and the like. Therefore, the power supply board PWB doubles as an LED driver board that drives the LEDs 17. The main board MB at least has a tuner part that can receive television signals, and an image processing part that conducts image-processing on the received television signals (neither the tuner part or the image processing part is shown in the figure), and can output the processed image signals to the control board CTB described below. When the liquid crystal display device 10 is connected to a not-shown external video playback device, an image signal from the video playback device is inputted into the main board MB, and the main board MB can output the image signal to the control board CTB after processing the signal at the image processing part. The control board CTB has the function of converting the image signal inputted from the main board MB to a signal for driving liquid crystal, and supplying the converted signal for liquid crystal to the liquid crystal panel 11.

As shown in FIG. 3, the liquid crystal display unit LDU that constitutes a part of the liquid crystal display device 10 is configured such that the main constituting components thereof are housed in a space between the frame (front frame) 13 that constitutes the front exterior and the chassis (rear chassis) 14 that constitutes the rear exterior. The main constituting components housed between the frame 13 and the chassis 14 at least include the liquid crystal panel 11, optical members 15, a light guide plate 16, and LED units (light source units) LU. Among them, the liquid crystal panel 11, the optical members 15, and the light guide plate 16 are stacked on top of the other, and are held by being sandwiched by the frame 13 disposed on the front side and the chassis 14 disposed on the rear side. The backlight device 12 is constituted of the optical members 15, the light guide plate 16, the LED units LU, and the chassis 14, and has the configuration that is obtained by removing the liquid crystal panel 11 and the frame 13 from the liquid crystal display unit LDU described above. A pair of LED units LU, which is a part of the backlight device 12, is disposed between the frame 13 and the chassis 14 so as to be on the respective sides of the light guide plate 16 in the shorter side direction (Y axis direction). Each LED unit LU is constituted of the LEDs 17, which are the light source, an LED substrate (light source substrate) 18 on which the LEDs 17 are mounted, and a heat dissipating member (heat spreader, light source attachment member) 19 to which the LED substrate 18 is attached. The respective constituting components will be explained below.

As shown in FIG. 3, the liquid crystal panel 11 is formed in a horizontally-long quadrangular shape (rectangular shape) in a plan view, and is configured by bonding a pair of glass substrates having high light transmittance to each other with a prescribed gap therebetween, and by injecting liquid crystal between the two substrates. Of the two substrates 11a and 11b, one on the front side (front surface side) is a CF substrate 11a, and the other on the rear side (rear surface side) is an array substrate 11b. In the array substrate 11b, switching elements (TFTs, for example) connected to source wiring lines and gate wiring lines that are intersecting with each other, pixel electrodes connected to the switching elements, an alignment film, and the like are provided. On the other hand, in the CF substrate 11a, color filters having respective colored portions such as R (red), G (green), and B (blue) arranged in a prescribed pattern, an opposite electrode, an alignment film, and the like are provided. Polarizing plates (not shown) are respectively provided on outer sides of the two substrates 11a and 11b.

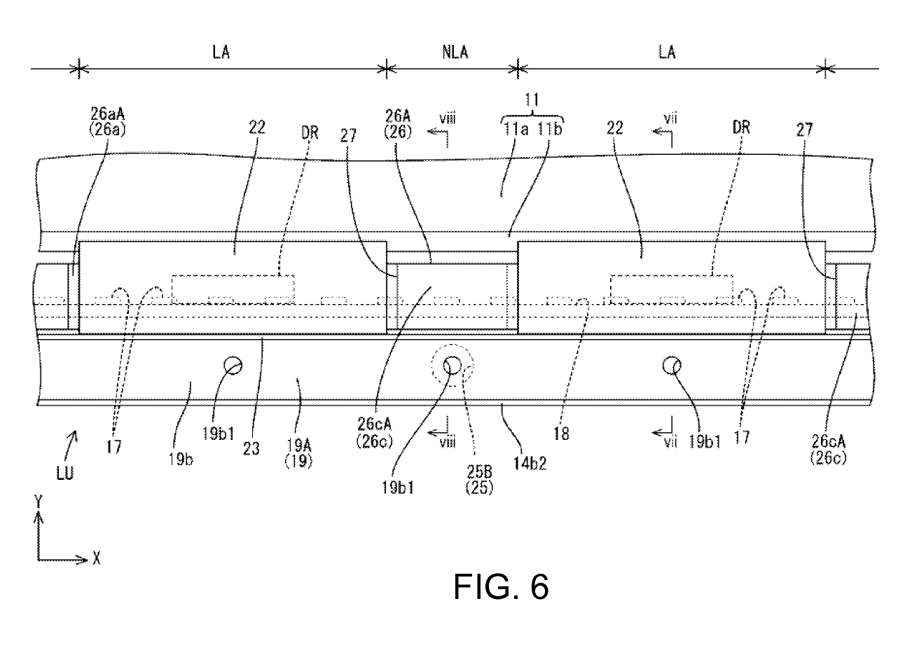

As shown in FIG. 4, of the pair of substrates 11a and 11b that constitutes a part of the liquid crystal panel 11, the array substrate 11b is formed larger than the CF substrate 11a in a plan view, and is disposed such that edge portions thereof protrude toward the outside beyond the CF substrate 11a. Of a pair of longer side edges of the array substrate 11b, a longer side edge (left side edge in FIG. 4) closer to the control board CTB in the Y axis direction has a plurality of terminals led out from the gate wiring lines and source wiring lines. As shown in FIGS. 2 and 6, the respective terminals are connected to flexible substrates (FPC substrates) 22 on which drivers DR for liquid crystal are respectively mounted. A plurality of flexible substrates 22 are arranged at intervals in a direction along the longer side edge of the array substrate 11b, or in other words, in the X axis direction, and protrude from the longer side edge of the array substrate 11b toward the outside along the Y axis direction. The flexible substrate 22 has a film-shaped base member made of a synthetic resin material having insulating properties and flexibility (such as a polyimide resin), and a plurality of wiring patterns (not shown) formed on the base member, and the wiring patterns are connected to a driver DR mounted near the center of the base member. One end of the flexible substrate 22 is crimp-connected to terminals of the array substrate 11b, and the other end thereof is crimp-connected to terminals of a printed board 23, which will be explained later, through anisotropic conductive films (ACF), respectively. The printed board 23 is connected to the above-mentioned control board CTB through a not-shown wiring member, and can transfer signals inputted from the control board CTB to the flexible substrates 22. This way, in the liquid crystal panel 11, an image is displayed on the display surface 1 lc based on the signals inputted from the control board CTB.

As shown in FIG. 4, the liquid crystal panel 11 is stacked on the front side of the optical members 15 described below, and the rear surface thereof (outer surface of a polarizing plate on the rear side) is in close contact with the optical members 15 with almost no gap. With this configuration, it is possible to prevent dust from entering a space between the liquid crystal panel 11 and the optical members 15. The display surface 11c of the liquid crystal panel 11 is constituted of a display region that is in the center of the surface and that can display images, and a non-display region that is in the outer edges of the surface and that is formed in a frame shape surrounding the display region. The terminals and the flexible substrates 22 are disposed in the non-display region.

As shown in FIG. 3, the optical members 15 have a horizontally-long quadrangular shape in a plan view as in the liquid crystal panel 11, and the size thereof (shorter side dimension and longer side dimension) is the same as that of the liquid crystal panel 11. The optical members 15 are stacked on the front side (side from which light is emitted) of the light guide plate 16 described below, and are sandwiched between the liquid crystal panel 11 described above and the light guide plate 16. Each of the optical members 15 is a sheet-shaped member, and the optical members 15 are constituted of three sheets stacked together. Specific types of optical members 15 include a diffusion sheet, a lens sheet, a reflective polarizing sheet, and the like, for example, and it is possible to appropriately choose any of these as optical members 15.

The light guide plate 16 is made of a synthetic resin (an acrylic resin such as PMMA or a polycarbonate, for example) with a higher refractive index than air and almost completely transparent (excellent light transmission). As shown in FIG. 3, the light guide plate 16 is a plate-shaped member that has a horizontally-long quadrangular shape in a plan view as in the liquid crystal panel 11 and the optical members 15 and that is thicker than the optical members 15. The longer side direction of the main surface corresponds to the X-axis direction, and the shorter side direction thereof corresponds to the Y axis direction, respectively. The thickness direction perpendicular to the main surface corresponds to the Z axis direction. The light guide plate 16 is placed on the rear side of the optical members 15, and is sandwiched between the optical members 15 and the chassis 14. As shown in FIG. 4, in the light guide plate 16, at least the shorter side dimension thereof is greater than the respective shorter side dimensions of the liquid crystal panel 11 and the optical members 15, and the light guide plate 16 is disposed such that respective edges in the shorter side direction (respective edges along the longer side direction) protrude toward outside beyond respective edges of the liquid crystal panel 11 and the optical members 15 (so as not to overlap in a plan view). At the respective sides in the shorter side direction of the light guide plate 16, a pair of LED units LU is disposed so as to have the light guide plate 16 interposed therebetween in the Y axis direction, and light from the LEDs 17 enters the respective shorter side edges of the light guide plate 16. The light guide plate 16 has the function of guiding therethrough the light of LEDs 17 that entered from the respective shorter side edges and emitting the light toward the optical members 15 (front side).

Of the main surfaces of the light guide plate 16, the surface facing the front side (surface facing the optical members 15) is a light output surface 16a that emits light from the interior toward the optical members 15 and the liquid crystal panel 11. Of the outer end faces continued from the main surfaces of the light guide plate 16, two end faces on the longer sides that are longer in the X axis direction (two end faces at the respective edges in the shorter side direction) respectively face the LEDs 17 (LED substrates 18) with a prescribed space therebetween, and these two end faces are a pair of light-receiving surfaces 16b through which light from the LEDs 17 enters. The light-receiving surfaces 16b are each on a plane parallel to that defined by the X axis direction and the Z axis direction (main surface of the LED substrate 18), and are substantially perpendicular to the light output surface 16a. The direction at which the LEDs 17 and the light-receiving surfaces 16b are aligned with respect to each other is the same as the Y axis direction, and is parallel to the light output surface 16a.

As shown in FIG. 4, on the rear side of the light guide plate 16, or in other words, on a surface 16c that is opposite to the light output surface 16a (surface facing the chassis 14), a light guide reflective sheet 20 is disposed so as to cover almost the entire area of the surface 16c. The light guide reflective sheet 20 can reflect light, which exited out from the surface 16c toward the rear side, back to the front side. In other words, the light guide reflective sheet 20 is sandwiched between the chassis 14 and the light guide plate 16. The light guide reflective sheet 20 is made of a synthetic resin, and the surface thereof is a highly reflective white. The shorter side dimension of the light guide reflective sheet 20 is greater than the shorter side dimension of the light guide plate 16, and the respective edges thereof protrude beyond the light-receiving surfaces 16b toward the LEDs 17. With the protruding portions of the light guide reflective sheet 20, light that travels diagonally and inwardly from the LEDs 17 toward the chassis 14 can be reflected efficiently, thereby directing the light toward the light-receiving surfaces 16b of the light guide plate 16. On at least one of the light output surface 16a and the opposite surface 16c of the light guide plate 16, a reflective portion (not shown) that reflects light from the interior or a diffusion portion (not shown) that diffuses light from the interior is patterned so as to have a prescribed in-plane distribution, thereby controlling light outputted from the light output surface 16a to have an even distribution in the plane.

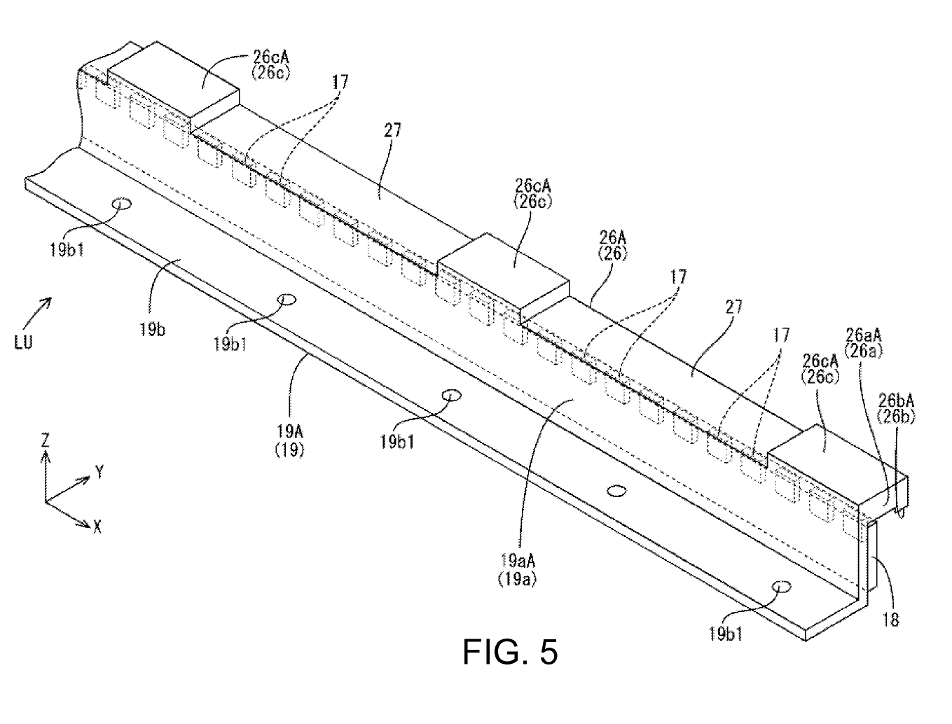

Next, configurations of the LEDs 17, the LED substrate 18, and the heat dissipating member 19 that constitute the LED unit LU will be explained in this order. As shown in FIGS. 4 and 5, the LEDs 17 of the LED units LU have a configuration in which an LED chip is sealed with a resin on a substrate part that is affixed to the LED substrate 18. The LED chip mounted on the substrate part has one type of primary light-emitting wavelength, and specifically, only emits blue light. On the other hand, the resin that seals the LED chip has a fluorescent material dispersed therein, the fluorescent material emitting light of a prescribed color by being excited by the blue light emitted from the LED chip. This combination of the LED chip and the fluorescent material causes white light to be emitted overall. As the fluorescent material, a yellow fluorescent material that emits yellow light, a green fluorescent material that emits green light, and a red fluorescent material that emits red light, for example, can be appropriately combined, or one of them can be used on its own. The LEDs 17 are of a so-called top-type in which the side opposite to that mounted onto the LED substrates 18 is the light-emitting surface.

As shown in FIGS. 4 and 5, the LED substrates 18 of the LED units LU are each formed in a narrow plate shape that extends along the longer side direction (X axis direction, longitudinal direction of the light-receiving surface 16b) of the light guide plate 16, and are housed between the frame 13 and the chassis 14 such that each main surface thereof is parallel to the X axis direction and the Z axis direction, or in other words, in parallel with the light-receiving surfaces 16b of the light guide plate 16. On the inner main surfaces of the respective LED substrates 18, or in other words, on the surfaces facing the light guide plate 16 (surfaces opposing the light guide plate 16), the LEDs 17 having the above-mentioned configuration are mounted, and these surfaces are mounting surfaces 18a. On the mounting surfaces 18a of the LED substrates 18, a plurality of LEDs 17 are arranged in a row (in a line) along the length direction (X axis direction) at prescribed intervals. That is, a plurality of LEDs 17 are arranged at intervals along the longer side direction on the respective longer edges of the backlight device 12. The intervals between respective adjacent LEDs 17 along the X axis direction are substantially equal to each other, or in other words, the LEDs 17 are arranged at substantially the same pitch. The arrangement direction of the LEDs 17 corresponds to the length direction (X axis direction) of the LED substrates 18. On the mounting surfaces 18a of the LED substrates 18, wiring patterns (not shown) made of a metal film (such as copper foil) are formed. The wiring patterns extend along the X axis direction and cross over the group of LEDs 17 so as to connect the adjacent LEDs 17 to each other in series. By connecting terminals that are formed at respective ends of the wiring patterns to the power supply board PWB via wiring members such as connectors and electric wires, driving power is supplied to the respective LEDs 17. Because the pair of LED substrates 18 is housed between the frame 13 and the chassis 14 such that the respective mounting surfaces 18a for the LEDs 17 face each other, the primary light-emitting surfaces of the respective LEDs 17 that are mounted on the two LED substrates 18 face each other, and the optical axis of each LED 17 substantially coincides with the Y axis direction. The base member of the LED substrate 18 is made of a metal such as aluminum, for example, and the above-described wiring pattern (not shown) is formed on the surface via an insulating layer. The base member of the LED substrate 18 may alternatively be formed of an insulating material such as ceramics.

As shown in FIGS. 4 and 5, the heat dissipating member 19 of the LED unit LU is made of a metal such as aluminum, for example, that has excellent heat conductivity. The heat dissipating member 19 is constituted of an LED attachment section (light source attachment section) 19a to which the LED substrate 18 is attached, and a heat dissipating section 19b that makes surface-to-surface contact with the plate surface of the chassis 14, and these two sections form a bent shape having a substantially L-shaped cross section. The LED attachment section 19a is in a plate shape that runs parallel to the surface of the LED substrate 18 and the light-receiving surface 16b of the light guide plate 16, and the longer side direction corresponds to the X axis direction, the shorter side direction corresponds to the Z axis direction, and the thickness direction corresponds to the Y axis direction, respectively. On the inner surface of the LED attachment section 19a, or in other words, on the surface that faces the light guide plate 16, the LED substrate 18 is attached. While the longer side dimension of the LED attachment section 19a is substantially the same as the longer side dimension of the LED substrate 18, the shorter side dimension of the LED attachment section 19a is greater than the shorter side dimension of the LED substrate 18. The respective edges of the LED attachment section 19a in the shorter side direction protrude toward outside beyond the respective edges of the LED substrate 18 along the Z axis direction. The outer surface of the LED attachment section 19a, or in other words, the surface opposite to the side where the LED substrate 18 is attached faces a protruding member 21 of the frame 13, which will be later described. That is, the LED attachment section 19a is interposed between the protruding member 21 of the frame 13 and the light guide plate 16. The LED attachment section 19a is configured to rise from the inner edge, or in other words, the edge closer to the LEDs 17 (light guide plate 16) of the heat dissipating section 19b described below toward the front side, or toward the frame 13 along the Z axis direction.

As shown in FIGS. 4 and 5, the heat dissipating section 19b is formed in a plate shape that is parallel to the surface of the chassis 14, and the long side direction corresponds to the X axis direction, the shorter side direction corresponds to the Y axis direction, and the thickness direction corresponds to the Z axis direction, respectively. The rear surface of the heat dissipating section 19b, or in other words, the surface facing the chassis 14, is entirely in contact with the surface of the chassis 14. As a result, heat generated from the LEDs 17 due to the illumination is transferred to the chassis 14 via the LED substrate 18, the LED attachment section 19a, and the heat dissipating section 19b, thereby being dissipated to the outside of the liquid crystal display device 10 efficiently, and therefore, the heat is less likely to be trapped inside. The longer side dimension of the heat dissipating section 19b is substantially the same as that of the LED attachment section 19a. The front surface of the heat dissipating section 19b, or in other words, the surface opposite to the side that is in contact with the chassis 14, faces the protruding member 21 of the frame 13, which will be later described. That is, the heat dissipating section 19b is interposed between the protruding member 21 of the frame 13 and the chassis 14. The heat dissipating section 19b is configured to be affixed to the protruding member 21 by a screw SM, and has an insertion hole 19b1 through which the screw SM passes. The heat dissipating section 19b protrudes from the rear edge, or in other words, the edge closer to the chassis 14, of the LED attachment section 19a toward the outside, or in other words, in the direction opposite to the light guide plate 16.

Next, the configurations of the frame 13 and the chassis 14 that constitute the exterior member and the holding member HM will be explained. The frame 13 and the chassis 14 are both made of a metal such as aluminum, for example, and have higher mechanical strength (rigidity) and heat conductivity as compared with the case in which the frame 13 and the chassis 14 are made of a synthetic resin. As shown in FIG. 3, the frame 13 and the chassis 14 hold the liquid crystal panel 11, the optical members 15, and the light guide plate 16, which are stacked on top of the other, by sandwiching these stacked components from the front side and the rear side, while housing the pair of LED units LU on the respective edges in the shorter side direction (respective longer side edges).

As shown in FIG. 3, the frame 13 is formed in a horizontally-long frame shape as a whole so as to surround the display region on the display surface 11c of the liquid crystal panel 11. The frame 13 is constituted of a panel pressing portion 13a that is disposed in parallel with the display surface 11c of the liquid crystal panel 11 and that presses the liquid crystal panel 11 from the front side, and side walls 13b that protrude from the outer edges of the panel pressing portion 13a toward the rear side, and has a substantially L-shaped cross section. The panel pressing portion 13a is formed in a horizontally-long frame shape as in the outer edge portion (non-display region, frame portion) of the liquid crystal panel 11, and can press almost the entire outer edges of the liquid crystal panel 11 from the front side. The panel pressing portion 13a is made wide enough to cover the respective longer edges of the light guide plate 16 that are located outside of the respective longer edges of the liquid crystal panel 11 in the Y axis direction, and the respective LED units LU from the front side, in addition to the outer edges of the liquid crystal panel 11. The front outer surface of the panel pressing portion 13a (surface opposite to the side facing the liquid crystal panel 11) is exposed to the outside on the front side of the liquid crystal display device 10 as in the display surface 11c of the liquid crystal panel 11, and constitutes the front side of the liquid crystal display device 10 together with the display surface 11c of the liquid crystal panel 11. On the other hand, the side walls 13b take the form of a substantially angular enclosure that rises from the outer edges of the panel pressing portion 13a toward the rear side. The side walls 13b can enclose the liquid crystal panel 11, the optical members 15, the light guide plate 16, and the LED units LU that are housed therein along almost the entire periphery thereof, and also can enclose the chassis 14 on the rear side along almost the entire periphery thereof. The outer surfaces of the side walls 13b along the circumference direction of the liquid crystal display device 10 are exposed to the outside in the circumference direction of the liquid crystal display device 10, and constitute the top face, the bottom face, and the side faces of the liquid crystal display device 10.

As shown in FIG. 4, in a pair of longer side portions of the panel pressing portion 13a that has a horizontally-long frame shape, protruding members 21 for attaching the LED units LU are integrally formed inside of the side walls 13b (closer to the light guide plate 16). The protruding members 21 protrude from the respective longer side portions of the panel pressing portion 13a toward the rear side along the Z axis direction, and are each formed in a substantially block shape that is horizontally long and that extends along the longer side direction (X axis direction). The protruding members 21 are respectively interposed between the side walls 13b of the frame 13 and the LED attachment sections 19a of the heat dissipating members 19 of the LED units LU. In the Z axis direction, the protruding member 21 is interposed between the panel pressing portion 13a of the frame 13 and the chassis 14. The protruding member 21 has a groove 21a formed therein that opens toward the rear side and that is used for attaching a screw (holding member) SM with which the LED unit LU and the like are affixed. The groove 21a is formed over the substantially entire length of the protruding member 21 along the longitudinal direction (X axis direction).

Between a protruding member 21 of the pair of protruding members 21 to which the heat-dissipating member 19A that corresponds in position to the flexible substrates 22 in a plan view is attached, and an LED attachment section 19aA of the heat-dissipating member 19A, as shown in FIG. 4, a space having a prescribed width is formed, and this space is a substrate housing space BS that can house the printed board 23 therein. Below, when it is necessary to differentiate respective heat-dissipating members 19, an index A is added to the reference character of the heat-dissipating member that corresponds in position to the flexible substrates 22 in a plan view (left side in FIG. 4), and an index B is added to the reference character of the heat-dissipating member that does not correspond in position to the flexible substrates 22 in a plan view (right side in FIG. 4). When it is not necessary to differentiate the heat-dissipating members, no index is added to the reference character. The printed board 23 is interposed between the protruding member 21 and the LED attachment section 19aA. The printed board 23 is made of a synthetic resin, and is formed in a horizontally-long plate shape that extends along the lengthwise direction of the protruding member 21 and the LED attachment section 19aA (X axis direction). The printed board 23 is housed in the substrate housing space BS such that the plate surface thereof is parallel to the outer plate surface (on the side opposite to the LED substrate 18) of the LED attachment section 19aA, or in other words, such that the longer side direction corresponds to the X axis direction, the shorter side direction corresponds to the Z axis direction, and the thickness direction corresponds to the Y axis direction. On the printed board 23, a plurality of flexible substrates 22 are arranged at intervals along the longer side direction, and other ends of the flexible substrates 22 are respectively connected to the printed board 23. The flexible substrates 22 that are connected to the printed board 23 and the array substrate 11b of the liquid crystal panel 11 bridge over the LED attachment section 19aA, the LED substrate 18, and the LEDs 17 along the Y axis direction. The printed board 23 also has a connector to which one end of the FPC is inserted and connected (neither the connector nor FPC is shown in the figures). The other end of the FPC is led out to the outside on the rear side of the chassis 14 through an FPC insertion hole (not shown) formed in the chassis 14, and is connected to the control board CTB.

As shown in FIG. 4, in the inner edge of the panel pressing portion 13a, a pressing protrusion 24 protruding toward the rear side, or in other words, toward the liquid crystal panel 11, is formed integrally with the panel pressing portion 13a. A buffer member 24a is attached to the protrusion end face of the pressing protrusion 24, and the pressing protrusion 24 can press the liquid crystal panel 11 via the buffer member 24a from the front side. The pressing protrusion 24 is formed in the two longer side portions and the two shorter side portions in the panel pressing portion 13a.

As shown in FIG. 3, the chassis 14 is formed in a substantially shallow plate shape that is horizontally long as a whole so as to almost entirely cover the light guide plate 16, the LED units LU, and the like from the rear side. The rear outer surface of the chassis 14 (surface opposite to the side facing the light guide plate 16 and the LED units LU) is exposed to the outside on the rear side of the liquid crystal display device 10, and constitutes the rear surface of the liquid crystal display device 10. The chassis 14 is constituted of a bottom plate 14a formed in a horizontally-long quadrangular shape as in the light guide plate 16, and a pair of LED housing portions (light source housing portions) 14b that protrude from the respective longer side edges of the bottom plate 14a toward the rear side in a step-like shape and that house the LED units LU, respectively. The bottom plate 14a is formed in a flat sheet shape that can receive the rear side of a large center portion of the light guide plate 16 (that does not include the respective longer side edges), or in other words, the bottom plate 14a constitutes a receiving portion for the light guide plate 16.

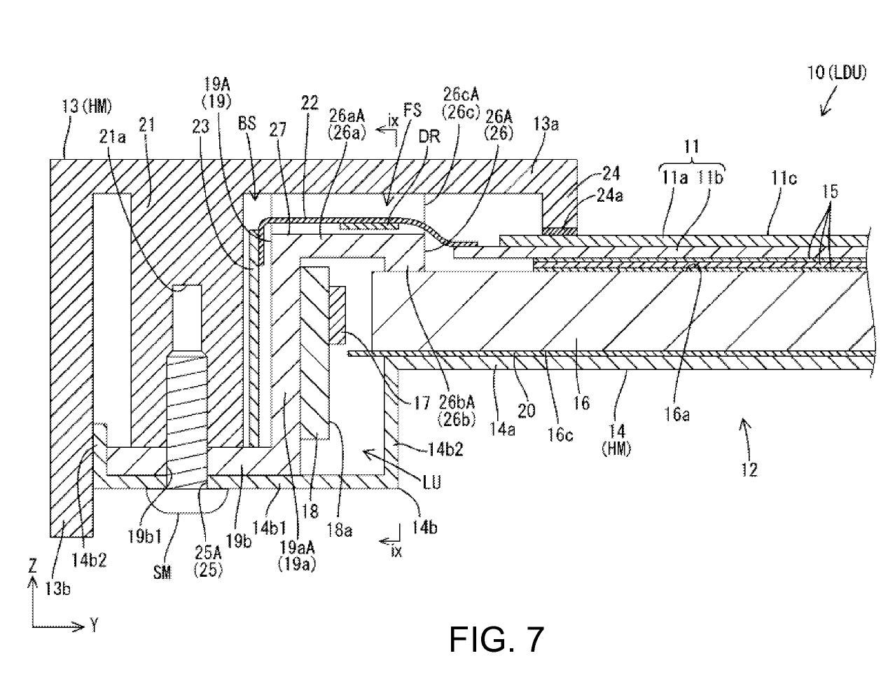

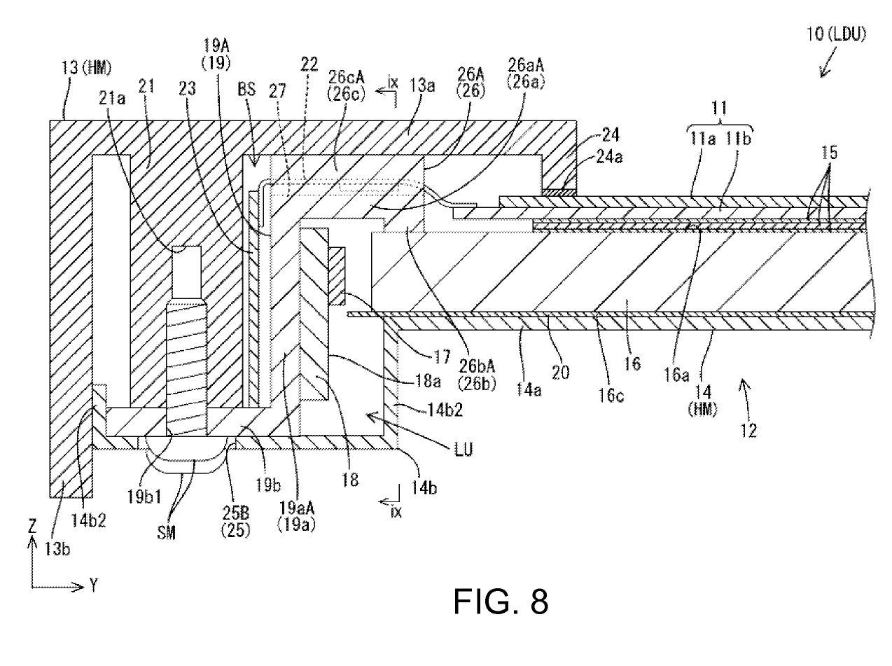

As shown in FIGS. 3 and 4, the LED housing portions 14b are disposed at the respective sides of the bottom plate 14a in the shorter side direction, and can house the LED units LU therein by being recessed toward the rear side from the bottom plate 14a. The LED housing portions 14b are each constituted of a housing portion bottom plate 14b1 that is in parallel with the bottom plate 14a, and a pair of housing portion side walls 14b2 that rise from the respective edges of the housing portion bottom plate 14b1 toward the front side, and of the pair of the housing portion side walls 14b2, the inner side wall 14b2 is continued to the bottom plate 14a. On the housing portion bottom plate 14b1 in each LED housing portion 14b, the heat dissipating section 19b of the heat dissipating member 19 of the LED unit LU is disposed so as to make surface-to-surface contact with the surface of the housing portion bottom plate 14b1. The housing portion bottom plate 14b1 has insertion holes 25 formed therein as openings, and screws SM for affixing the heat dissipating section 19b and the housing portion bottom plate 14b1 to the protruding member 21 are to pass through the insertion holes 25. The insertion holes 25 include an insertion hole 25A for jointly fastening a plurality of parts that is large enough only to allow the shaft portion of the screw SM to pass through as shown in FIG. 7, and an insertion hole 25B for the heat dissipating member that is large enough to allow not only the shaft portion, but also the head of the screw SM to pass through as shown in FIG. 8. The screw SM going through the former fastens both of the heat dissipating section 19b and the housing portion bottom plate 14b1 to the protruding member 21, while the screw SM going through the latter fastens only the heat dissipating section 19b to the protruding member 21.

As shown in FIG. 4, the heat-dissipating member 19 of the present embodiment is provided with a light-shielding member 26 that is interposed between the LEDs 17 and the liquid crystal panel 11, thereby blocking light from the LEDs 17 from directly entering the liquid crystal panel 11. The light-shielding member 26 is formed integrally with the heat-dissipating member 19, and protrudes from the front edge of the LED attachment section 19a (the side closer to the frame 13, the side opposite to the heat-dissipating section 19b) toward the inner side, or in other words, toward the liquid crystal panel 11 and the light guide plate 16. The light-shielding member 26 is interposed between the printed board 23 and the liquid crystal panel 11 with respect to the Y axis direction, and between the panel pressing portion 13a of the frame 13, and the LED substrate 18 and the light guide plate 16 with respect to the Z axis direction, respectively. The light-shielding member 26 extends along the longer side direction (X axis direction) of the LED attachment section 19a, and has substantially the same length dimension as that of the LED attachment section 19a.

As shown in FIG. 4, the light-shielding member 26 has: a light-shielding base 26a that protrudes from the front edge of the LED attachment section 19a toward the inside along the Y axis direction (extending direction of the flexible substrate 22, the direction along which the LEDs 17 and the light guide plate 16 are arranged), thereby taking the form of a cantilevered part; a light guide plate supporting portion 26b that protrudes from the light-shielding base 26a toward the rear side, or toward the light guide plate 16, and that abuts on the light guide plate 16; and a heat dissipation accelerating portion 26c that protrudes from the light-shielding base 26a toward the front side, or toward the frame 13, and that abuts on the frame 13. The light-shielding member 26 has a substantially L-shaped cross-section as a whole.

As shown in FIGS. 4 and 5, the light-shielding base 26a is a plate-shaped section that is parallel to the surface of the heat-dissipating section 19b, and the longer side direction coincides with the X axis direction, the shorter side direction coincides with the Y axis direction, and the thickness direction coincides with the Z axis direction, respectively. The light-shielding base 26a protrudes from the front edge of the LED attachment section 19a toward the inside (in a direction opposite to the heat-dissipating section 19b) along the Y axis direction, thereby covering the LED substrate 18, LEDs 17, space between the LEDs 17 and the light guide plate 16, and the edge of the light guide plate 16 facing the LEDs 17 (longer side edge having the light-receiving surface 16b) from the front side. The light-shielding base 26a extends along the respective longer side edges (X axis direction) of the LED substrate 18 and the liquid crystal panel 11 in the entire length thereof, and therefore, the light-shielding base 26a covers all of the LEDs 17 mounted on the LED substrate 18 collectively from the front side. By blocking light from the respective LEDs 17 by the light-shielding base 26a, the light is prevented from leaking to the front side of the light-shielding base 26a. The light-shielding base 26a extends so as to cover the edge of the light guide plate 16 that faces the LEDs 17 in a plan view, and therefore, light emitted from the LEDs 17 and travelling diagonally and inwardly toward the front side, or in other words, toward the liquid crystal panel 11 and the optical members 15, can also be blocked in a desired manner. When reaching the light-shielding base 26a, light from the LEDs 17 is reflected thereby, and is efficiently guided to the light-receiving surface 16b of the light guide plate 16.

As shown in FIGS. 4 and 5, the light guide plate supporting portion 26b is formed in a hook-like shape that protrudes from the protruding end of the light-shielding base 26a toward the rear side along the Z axis direction (direction along which the light guide plate 16 and the liquid crystal panel 11 are stacked). The light guide plate supporting portion 26b extends along the longer side direction (X axis direction) of the light-shielding base 26a in the entire length thereof. The light guide plate supporting portion 26b is configured such that the protrusion end face thereof abuts on the front side surface, or in other words, the light output surface 16a, of the light guide plate 16, thereby blocking the gap between the light-shielding base 26a and the light guide plate 16. As a result, light from the LEDs 17 is more reliably prevented from leaking toward the inside, or in other words, toward the liquid crystal panel 11 and the optical members 15 through the gap between the light-shielding base 26a and the light guide plate 16. The light guide plate supporting portion 26b extends along the longer side edge (X axis direction) of the LED substrate 18 and the liquid crystal panel 11 in the entire length thereof, and therefore, it is possible to block light collectively from all of the LEDs 17 mounted on the LED substrate 18 without any leak. As described above, with the light-shielding base 26a and the light guide plate supporting portion 26b of the light-shielding member 26, the space where the LEDs 17 are disposed and the space where the liquid crystal panel 11 and the optical members 15 are disposed are optically separated from each other (optically independent of each other), and a passage of light therebetween is blocked. Thus, light from the LEDs 17 can be prevented from directly entering the respective end faces of the liquid crystal panel 11 and the optical members 15 that are facing the LEDs 17 without passing through the light guide plate 16.

As shown in FIGS. 4 and 5, the light guide plate supporting portion 26b abuts on a portion of the light guide plate 16 that protrudes beyond the liquid crystal panel 11 and the optical members 15 toward the LEDs 17. Therefore, the light guide plate supporting portion 26b can support the light guide plate 16 by sandwiching the light guide plate 16 with the chassis 14 (bottom plate 14a). The portions of the light guide plate 16 where the light guide plate supporting portions 26b abut are the edges (longer side edges) that respectively have the light-receiving surfaces 16b facing the LEDs 17, and therefore, by supporting the light guide plate 16 by the light guide plate supporting portions 26b, it is possible to achieve a stable positional relationship between the LEDs 17 and the light-receiving surfaces 16b with respect to the Z axis direction. The light guide plate supporting portions 26b are formed so as to cover the longer side edges of the light guide plate 16 and the longer side edges of the bottom plate 14a of the chassis 14 in a plan view with respect to the Y axis direction (direction along which the LEDs 17 and the liquid crystal panel 11 are arranged).

As shown in FIGS. 4 and 5, the heat dissipation accelerating portion 26c is formed in a substantially block shape that protrudes from the light-shielding base 26a toward the front side along the Z axis direction (direction along which the light guide plate 16 and the liquid crystal panel 11 are stacked). The heat dissipation accelerating portion 26c is formed over the entire length of the light-shielding base 26a with respect to the Y axis direction. The heat dissipation accelerating portion 26c is configured such that the protrusion end face thereof makes surface-to-surface contact with the rear surface of the panel pressing portion 13a of the frame 13 over the entire area. With this configuration, heat generated from the LEDs 17 due to illumination is transferred to the frame 13 through the LED substrate 18, the LED attachment section 19a, the light-shielding base 26a, and the heat dissipation accelerating portion 26c, and is efficiently dissipated to the outside of the liquid crystal display device 10. As a result, the heat is less likely to be trapped inside of the display device. The heat dissipation accelerating portion 26c overlaps the light guide plate supporting portion 26b in a plan view, and can therefore receive the light guide plate supporting portion 26b that abuts on the light guide plate 16 from the front side together with the panel pressing portion 13a of the frame 13, which can improve the rigidity of the light guide plate supporting portion 26b. Thus, by being sandwiched and pressed between the light guide plate supporting portion 26b that has an improved rigidity by the panel pressing portion 13a of the frame 13 and the heat dissipation accelerating portion 26c, and the bottom plate 14a of the chassis 14, the respective longer side edges of the light guide plate 16 can be accurately positioned with respect to the Z axis direction. This makes it possible to achieve more stable positional relationship between the LEDs 17 and the light-receiving surfaces 16b of the light guide plate 16 with respect to the Z axis direction.

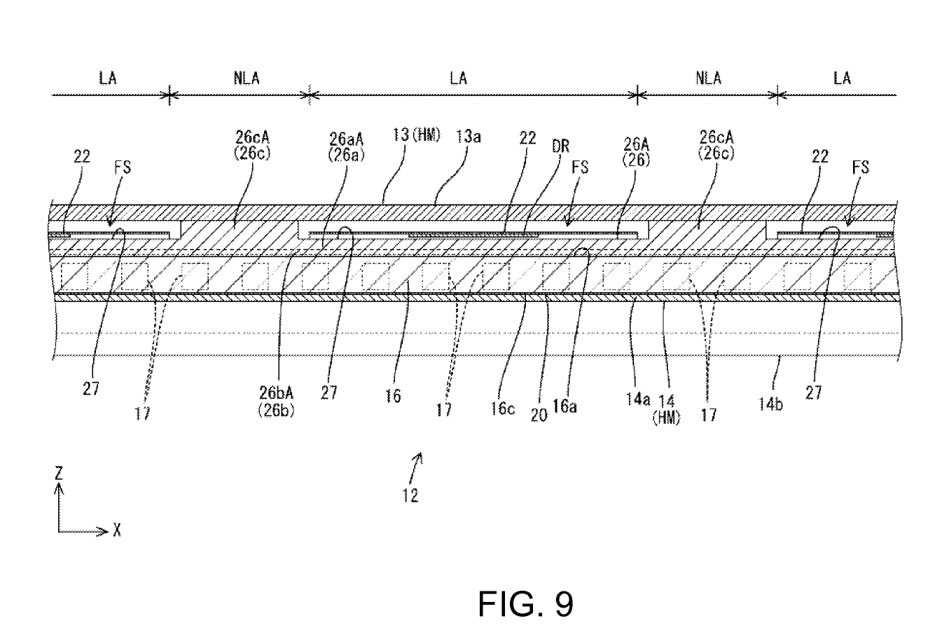

As shown in FIGS. 7 and 9, between the light-shielding member 26A of the heat-dissipating member 19A that overlaps the flexible substrates 22 in a plan view (left side of FIG. 4), of the pair of heat-dissipating members 19, and the panel pressing portion 13a of the frame 13 on the front side, flexible substrate passages FS are formed where the flexible substrates 22 respectively go through. Below, when it is necessary to differentiate respective light-shielding members 26, an index A is added to the reference character of the light-shielding member that corresponds in position to the flexible substrates 22 in a plan view (left side in FIG. 4), and an index B is added to the reference character of the light-shielding member that does not correspond in position to the flexible substrates 22 in a plan view (right side in FIG. 4). When it is not necessary to differentiate the light-shielding members, no index is added to the reference character.

As shown in FIGS. 5 to 7, adjacent to the heat dissipation accelerating portion 26cA of the light-shielding member 26A of the heat-dissipating member 19A that corresponds in position to the flexible substrates 22 in a plan view, flexible substrate passage recesses 27 are formed to secure the above-mentioned flexible substrate passages FS. The flexible substrate passage recesses 27 are formed over the entire length of the light-shielding member 26A with respect to the Y axis direction, and open toward the front side, or in other words, toward the frame 14 with respect to the Z axis direction. A plurality of flexible substrate passage recesses 27 are arranged at intervals along the X axis direction, or in other words, the direction in which the flexible substrates 22 are arranged, and respectively correspond in position to overlapping sections LA that overlap the respective flexible substrates 22 in a plan view. The flexible substrate 22 that goes through each flexible substrate passage recess 27 is disposed such that the driver DR mounted thereof faces the rear side, or in other words, the bottom surface of the flexible substrate passage recess 27 (side opposite to the panel receiving portion 13a of the frame 13). On the other hand, as shown in FIGS. 5, 6, and 8, a plurality of heat dissipation accelerating portion 26cA where the flexible substrate passage recesses 27 are not formed are arranged at intervals along the X axis direction, and respectively correspond in position to non-overlapping sections NLA that do not overlap the respective flexible substrates 22 in a plan view. In the liquid crystal display device 10, the overlapping sections LA that overlap the respective flexible substrates 22 in a plan view, and the non-overlapping section NLA that do not overlap the respective flexible substrates 22 are alternately arranged along the X axis direction. As shown in FIGS. 5 to 7, each flexible substrate passage FS is surrounded by wall surfaces of the flexible substrate passage recess 27 (surface facing the panel pressing portion 13a of the light-shielding base 26aA, and side faces of the heat dissipation accelerating portion 26cA) and the inner wall surface of the panel pressing portion 13a of the frame 13. The flexible substrate passage FS is connected to the substrate housing space BS in which the printed board 23 is housed, and opens toward the longer side edge of the liquid crystal panel 11.

As described above, as shown in FIGS. 7 and 9, in the overlapping sections LA that overlap the respective flexible substrates 22 in a plan view, the flexible substrate passage recesses 27 are formed in the light-shielding member 26A, thereby securing the flexible substrate passage spaces FS between the panel pressing portion 13a of the frame 13 on the front side and the light-shielding base 26aA, which allows the flexible substrates 22 connected to the liquid crystal panel 11 and the printed board 23 to pass through. On the other hand, as shown in FIGS. 8 and 9, in the non-overlapping sections NLA that do not overlap the respective flexible substrates 22 in a plan view, the heat dissipation accelerating portions 26cA are formed in the light-shielding member 26A, thereby making it possible to efficiently transfer heat from the LEDs 17 to the frame 13 as described above, and as a result, excellent heat dissipating property is achieved. As shown in FIGS. 7 to 9, the light-shielding base 26aA and the light guide plate supporting portion 26bA of the light-shielding member 26A are formed so as to extend over all of the overlapping sections LA and the non-overlapping sections NLA, and therefore, regardless of the presence of the flexible substrates 22, light from the LEDs 17 can be prevented from directly entering the longer side edges of the liquid crystal panel 11 and the optical members 15 over the entire length thereof. As a result, excellent light-shielding property can be achieved. As shown in FIG. 4, in the heat-dissipating member 19B located in a position that does not overlap the flexible substrates 22 (located on the side opposite to the side where the flexible substrates 22 are disposed), the flexible substrate passage recess 27 is not formed in the heat dissipation accelerating portion 26cB of the light-shielding member 26B, and the heat dissipation accelerating portion 26cB extends along the entire length of the light-shielding base 26aB in the longer side direction (X axis direction), and the entire area thereof makes surface-to-surface contact with the panel pressing portion 13a of the frame 13.

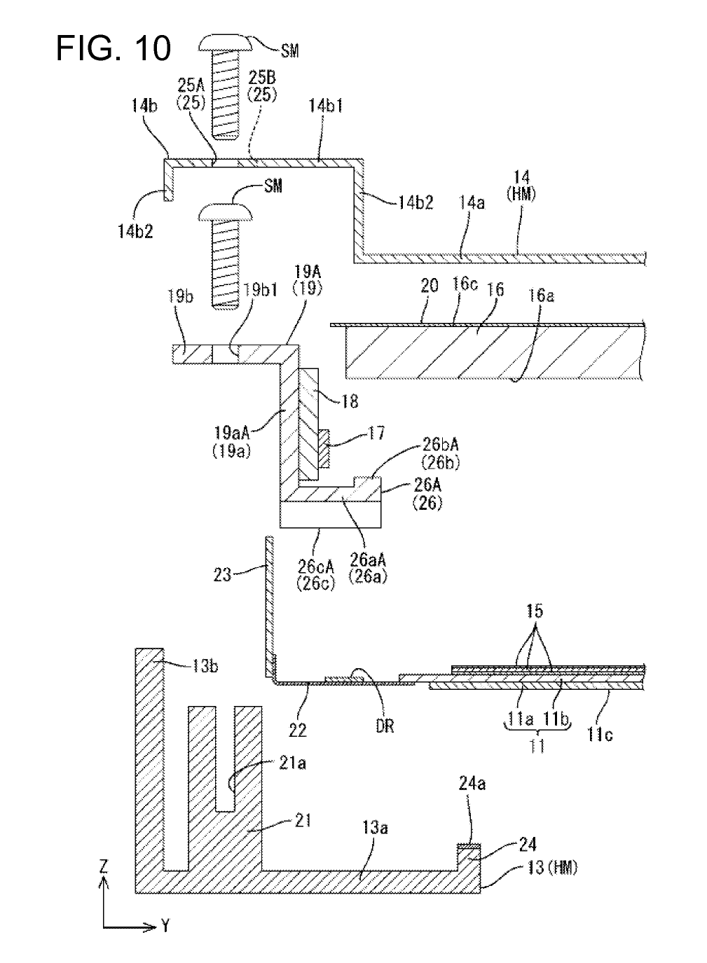

The present embodiment has the above-mentioned structure, and the operation thereof will be explained next. The liquid crystal display device 10 is manufactured by assembling respective constituting components that are manufactured separately (frame 13, chassis 14, liquid crystal panel 11, optical members 15, light guide plate 16, LED units LU, and the like) together. In the assembly process, the respective constituting components are assembled after being flipped over with respect to the Z axis direction from the position shown in FIGS. 4 and 6. First, as shown in FIG. 10, among the constituting components, the frame 13 is set on a not-shown work table such that the rear side thereof faces up in the vertical direction.

As shown in FIG. 10, the liquid crystal panel 11 has the flexible substrates 22 and the printed board 23 connected thereto before being brought to the assembly process. On the frame 13 that has been set with the orientation described above, as shown in FIG. 10, the liquid crystal panel 11 is placed with the CF substrate 11a down and the array substrate 11b up in the vertical direction. The printed board 23 is attached to the protruding member 21 such that the surface thereof lies along the surface of the protruding member 21 of the frame 13 that faces the liquid crystal panel 11. Thus, the flexible substrates 22 are bent into a substantially L-shaped in the middle. The front surface of the liquid crystal panel 11 is received by the buffer member 24a attached to the pressing protrusion 24 of the frame 13 to absorb shock. Next, the respective optical members 15 are directly stacked on the rear side of the liquid crystal panel 11 in an appropriate order.

On the other hand, as shown in FIG. 10, the LED units LU each having the LEDs 17, the LED substrate 18, and the heat dissipating member 19 assembled together are attached to the frame 13. The LED units LU are respectively attached to the protruding members 21 of the frame 13 such that the LEDs 17 are oriented toward the center (inner side) of the frame 13, and such that the heat dissipating sections 19b of the heat dissipating members 19 face the protruding members 21 of the frame 16. One of the pair of LED units LU that is located in a position overlapping the flexible substrates 22 in a plan view is attached while positioning the respective flexible substrate passage recesses 27 of the heat-dissipating member 19A with respect to the respective flexible substrates 22 in the X axis direction. When the heat-dissipating member 19A is attached to the protruding member 21, a substrate housing space BS is formed between the LED attachment section 19aA thereof and the protruding member 21, and the printed board 23 is housed therein. Between the panel pressing portion 13a of the frame 13 and the light-shielding base 26aA of the light-shielding member 26A, flexible substrate passages FS are formed in the overlapping sections LA, and the flexible substrates 22 are installed to pass therethrough. The respective heat dissipation accelerating portions 26bA formed in the non-overlapping sections NLA respectively make surface-to-surface contact with the panel pressing portion 13a of the frame 13. In terms of the other of the pair of LED units LU that is located in a position not overlapping the flexible substrates 22 in a plan view, when the heat-dissipating member 19B is attached to the protruding member 21, the heat dissipation accelerating portion 26bB makes surface-to-surface contact with the panel pressing portion 13a of the frame 13 over the entire area thereof. When the respective LED units LU are attached to the respective protruding members 21, the respective insertion holes 19b1 of the heat-dissipating section 19b are connected to the grooves 21a of the protruding members 21.

After attaching the LED units LU to the protruding members 21 in the above-mentioned manner, as shown in FIG. 10, screws SM are made to pass through corresponding insertion holes 19b1 of the heat dissipating sections 19b, and are screwed into the grooves 21a of the protruding members 21. With the screws SM, the LED units LU are affixed to the protruding members 21 in the stage before the chassis 14 is attached in a manner described below (see FIG. 8). The LED units LU may be attached to the frame 13 before the optical members 15 are attached or the liquid crystal panel 11 is attached.

After fastening the LED units LU to the protruding members 21 with screws, as shown in FIG. 10, the light guide plate 16 having the light guide reflective sheet 20 attached thereto is directly stacked on the rear side of the rearmost part of the optical members 15. The respective longer side edges of the light guide plate 16 are supported by the light guide plate supporting portions 26b of the light-shielding members 26 in the heat-dissipating members 19 from the lower side (front side) of the vertical direction in the assembly process.

After attaching the liquid crystal panel 11, the optical members 15, the light guide plate, and the LED units LU to the frame 13 as described above, a process to attach the chassis 14 is conducted. As shown in FIG. 10, the chassis 14 is attached to the frame 13 with the front side thereof down in the vertical direction. At this time, by having the respective outer housing portion side walls 14b2 of the respective LED housing portions 14b of the chassis 14 make contact with the inner surfaces of the side walls 13b on the respective longer sides of the frame 13, the chassis 14 can be positioned with respect to the frame 13. In the assembly process, heads of the screws SM that were installed in the heat dissipating members 19 and the protruding members 21 in advance are made to pass through the respective heat dissipating member insertion holes 25B in the respective LED housing portions 14b of the chassis 14 (see FIG. 8). Then, when the bottom plate 14a of the chassis 14 makes contact with the light guide plate 16 (light guide reflective sheet 20) and the housing portion bottom plates 14b1 of the respective LED housing portions 14b make contact with the heat dissipating sections 19b of the respective heat dissipating members 19, screws SM are made to pass through the insertion holes 25A for jointly fastening a plurality of parts, and the screws SM are screwed into the grooves 21a of the protruding members 21. With the screws SM, the LED units LU and the chassis 14 are affixed to the protruding members 21 (see FIGS. 7 and 8).

The assembly of the liquid crystal display unit LDU is completed in the manner described above. Next, after the stand attachment member STA and various boards PWB, MB, and CTB are attached to the rear side of the liquid crystal display unit LDU, the stand ST and the cover member CV are attached to the rear side, thereby completing the liquid crystal display device 10 and the television receiver TV. In the liquid crystal display device 10 manufactured in this manner, the exterior thereof is constituted of the frame 13 that presses the liquid crystal panel 11 from the display surface 11c side, and the chassis 14 of the backlight device 12, and the liquid crystal panel 11 is directly stacked on the optical members 15. Therefore, as compared with a conventional configuration in which a cabinet made of a synthetic resin is provided in addition to the frame 13 and the chassis 14, or in which a panel receiving member is provided between the liquid crystal panel 11 and the optical members 15 so as to keep the two from making contact with each other, the number of parts and the assembly man-hour can be reduced, resulting in a lower manufacturing cost, and the size and weight reduction.

As shown in FIG. 4, when the liquid crystal display device 10 manufactured as described above is turned on, power is supplied from the power supply board PWB, causing various signals to be sent from the control board CTB to the liquid crystal panel 11 via the printed board 23 and the flexible substrates 22 (drivers DR), thereby controlling the drive thereof, and causing the respective LEDs 17 of the backlight device 12 to be driven. By passing through the optical members 15 after being guided by the light guide plate 16, light from the respective LEDs 17 is converted to even planar light, which then illuminates the liquid crystal panel 11, and a prescribed image is displayed on the liquid crystal panel 11. To explain the operation of the backlight device 12 in detail, when the respective LEDs 17 are lit, light emitted from the respective LEDs 17 enters the light-receiving surfaces 16b of the light guide plate 16 as shown in FIG. 7. In the process of travelling through the light guide plate 16 while being subject to the total reflection at the interfaces between the light guide plate 16 and external air spaces, being reflected by the light guide reflective sheet 20, and the like, the light that entered the light-receiving surfaces 16b is reflected or diffused by not-shown reflective portions and diffusion portions, thereby being outputted from the light output surface 16a and being radiated to the optical members 15.

In the liquid crystal display device 10 of the present embodiment, the liquid crystal panel 11 is directly stacked on the light guide plate 16 and the optical members 15, and a panel receiving member is not interposed therebetween unlike the conventional configuration. Therefore, if the panel receiving member is simply eliminated, the space where the LEDs 17 are disposed would be connected to the space where the liquid crystal panel 11 is disposed, and light from the LEDs 17 would directly enter the end faces of the liquid crystal panel 11 without passing through the light guide plate 16. In the present embodiment, however, as shown in FIG. 7, each heat-dissipating member 19 is provided with the light-shielding member 26 that is interposed between the LEDs 17 and the liquid crystal panel 11, and the space where the LEDs 17 are disposed and the space where the liquid crystal panel 11 is disposed are optically separated from each other. As a result, light from the LEDs 17 can be prevented from directly entering the end faces of the liquid crystal panel 11 without passing through the light guide plate 16, and therefore, it is possible to prevent the degradation of display quality caused by the light leakage. The light-shielding member 26 has the light guide plate supporting portion 26b that abuts on the front surface of the light guide plate 16, in addition to the light-shielding base 26a, and therefore, a light passage between the space where the LEDs 17 are disposed and the space where the liquid crystal panel 11 is disposed is more reliably blocked. As a result, light-shielding property can be further improved. Furthermore, the light guide plate 16 is pressed between the light guide plate supporting portion 26b and the bottom plate 14a of the chassis 14, and the light guide plate supporting portion 26b is received by the heat dissipation accelerating portion 26c and the panel pressing portion 13a of the frame 13 from the front side, thereby having improved rigidity. This makes it possible to accurately position the light-receiving surfaces 16b with respect to the LEDs 17 in the Z axis direction, and as a result, the incident efficiency of light that enters the light-receiving surfaces 16b from the LEDs 17 can be made stable.

As shown in FIGS. 7 and 9, the light-shielding member 26A located in the position overlapping the flexible substrates 22 in a plan view is provided in the heat-dissipating member 19A, and therefore, flexible substrate passages FS are formed between the light-shielding member 26A and the panel pressing portion 13a of the frame 13 so as to allow the flexible substrates 22 to go through. If the light-shielding member that is interposed between the LEDs 17 and the liquid crystal panel 11 is provided in the frame 13, such a configuration would not allow the flexible substrates 22 to be installed, and if the light-shielding member is configured to avoid such a problem, it would not be possible to shield light in positions overlapping the flexible substrates 22. On the other hand, in the present embodiment, the light-shielding member 26A is provided in the heat-dissipating member 19A, not in the frame 13, and therefore, it is possible to achieve the light-shielding function of the light-shielding member 26A even in positions overlapping the flexible substrates 22 (overlapping sections LA) while allowing the flexible substrates 22 to be installed. As a result, regardless of the presence of the flexible substrates 22, light from the LEDs 17 can be prevented from directly entering the end faces of the liquid crystal panel 11 without passing through the light guide plate 16, and therefore, it is possible to prevent the degradation of display quality caused by the light leakage. The light-shielding member 26A extends over the overlapping sections LA and the non-overlapping sections NLA, and as compared with a configuration in which the light-shielding member is divided into several parts corresponding to the overlapping sections LA and the non-overlapping sections NLA, sufficient light-shielding property can be achieved at borders between the overlapping sections LA and the non-overlapping sections NLA, and light leakage can be prevented more reliably.

When the respective LEDs 17 are lit in order to use the liquid crystal display device 10, heat is generated from the respective LEDs 17. As shown in FIGS. 7 to 9, heat generated from the respective LEDs 17 is first transferred to the LED substrates 18, and then transferred to the heat dissipating members 19. The heat dissipating member 19 has the heat-dissipating section 19b that is attached to the protruding member 21 of the frame 13 and the housing portion bottom plate 14b1 of the LED housing portion 14b, and heat from LEDs 17 is transferred to the frame 13 and the chassis 14 through the heat-dissipating section 19b. The contact area of the heat-dissipating section 19b with the chassis 14 is larger than the contact area thereof with the frame 13, and therefore, more heat is transferred to the chassis 14. Because the heat dissipating member 19 has the heat dissipation accelerating portion 26c of the light-shielding member 26, which makes surface-to-surface contact with the panel pressing portion 13a of the frame 13, heat from the LEDs 17 can also be transferred to the panel pressing portion 13a through the heat dissipation accelerating portion 26c. In this manner, heat from the LEDs 17 can be dissipated to the outside using the thermal capacity of the frame 13 and the chassis 14, and as a result, heat is less likely to be trapped inside of the liquid crystal display device 10.

As described above, the liquid crystal display device (display device) 10 of the present embodiment includes: the LEDs (light source) 17; the heat-dissipating members (light source attachment member) 19 to which the LEDs 17 are attached; the liquid crystal panel (display panel) 11 that conducts display using light from the LEDs 17; the flexible substrates 22 that are connected to an edge of the liquid crystal panel 11; the light guide plate 16 disposed on a side of the liquid crystal panel 11 opposite to the display surface 11c thereof, the light guide plate 16 being disposed such that end faces thereof face the LEDs 17; the holding member HM that has a pair of frame 13 and chassis 14 (holding parts) that sandwich the liquid crystal panel 11 and the light guide plate 16 from a side of the display device where the display surface 11c is disposed and a side opposite thereto, the holding member HM housing the LEDs 17, the heat-dissipating members 19, and the flexible substrates 22 between the pair of frame 13 and chassis 14; and the light-shielding members 26 provided in the heat-dissipating members 19, the light-shielding members 26 blocking light from the LEDs 17 from directly entering the liquid crystal panel 11, the light-shielding members 26 each being configured such that flexible substrate passages where the flexible substrates 22 go through are formed between the light-shielding member 26 and the frame 13, of the pair of frame 13 and chassis 14, that is disposed on the display surface 11c.

With this configuration, light emitted from the LEDs 17 is guided to the liquid crystal panel 11 after entering the end faces of the liquid guide plate 16 facing the LEDs 17, and using this light, an image is displayed on the liquid crystal panel 11. The liquid crystal panel 11 and the light guide plate 16 are stacked and are sandwiched by the pair of frame 13 and chassis 14 of the holding member HM from the display surface 11c side and the opposite side thereto, and a panel receiving member is not interposed between the light guide plate 16 and the liquid crystal panel 11 unlike the conventional configuration. Therefore, light from the LEDs 17 would directly enter the edges of the liquid display panel 11 without passing through the light guide plate 16. However, because the heat-dissipating members 19 are provided with the light-shielding members 26 that are interposed between the liquid crystal panel 11 and the LEDs 17, light from the LEDs 17 can be prevented from directly entering the edges of the liquid crystal panel 11 without passing through the light guide plate 16 by the light-shielding members 26. As a result, a light leakage can be prevented. By the light-shielding member 26 being provided in the heat-dissipating member 19, the flexible substrate passages FS where the flexible substrates 22 go through can be formed between the light-shielding member 26 and the frame 13, of the pair of frame 13 and the chassis 14, that is disposed on the display surface 11c side. If the light-shielding member 26 that is interposed between the LEDs 17 and the light guide plate 16 is provided in the frame that is disposed on the display surface 11c side, such a configuration would not allow the flexible substrates 22 to be installed, and if the light-shielding member 26 is configured to avoid such a problem, it would not be possible to shield light in positions overlapping the flexible substrates 22. On the other hand, with the above-mentioned configuration, it is possible to achieve the light-shielding function of the light-shielding member 26 even in positions overlapping the flexible substrates 22 while allowing the flexible substrates 22 to be installed, and therefore, light leakage caused by the flexible substrates 22 can also be prevented.

A plurality of the flexible substrates 22 are arranged at intervals in a direction along the edge of the liquid crystal panel 11, and the light-shielding member 26 is disposed so as to extend across overlapping sections LA that overlap the flexible substrates 22 in a plan view and non-overlapping sections NLA that do not overlap the flexible substrates 22 in a plan view. With this configuration, in both of the overlapping sections LA and the non-overlapping sections NLA, light from the LEDs 17 can be prevented from directly entering the edge of the liquid crystal panel 11 without passing through the light guide plate 16 by the light-shielding member 26, and in addition, at the borders between the overlapping sections LA and the non-overlapping sections NLA, light from the LEDs 17 can be shielded by the light-shielding member 26 disposed so as to extend over the two regions. Thus, light leakage can be prevented more reliably.

The light-shielding member 26 has the heat dissipation accelerating portions 26c in portions thereof that are disposed in the non-overlapping sections NLA, the heat dissipation accelerating portions 26c abutting on the frame 13, of the pair of frame 13 and chassis 14, that is disposed on the display surface 11c. With this configuration, heat generated by the LEDs 17 when the LEDs 17 are lit is transferred from the LEDs 17 to the heat-dissipating member 19, and then further to the frame 13 that is disposed on the display surface 11c side and that has the heat dissipation accelerating portions 26c of the light-shielding member 26 abutting thereon, and the chassis 14. Therefore, heat is dissipated efficiently using the thermal capacity of the frame 13. The heat dissipation accelerating portions 26c are disposed in the non-overlapping sections NLA that do not overlap the flexible substrates 22 in a plan view, and therefore, the heat dissipation accelerating portions 26c do not block the flexible substrate passages FS where the flexible substrates 22 go through.

The light-shielding member 26 has the light guide plate supporting portion 26b at least in a portion thereof that is disposed in the non-overlapping section NLA, the light guide plate supporting portion 26b abutting on a surface of the light guide plate 16 that faces the liquid crystal panel 11. In this configuration, the light guide plate supporting portion 26b formed in the light-shielding member 26 abuts on the light guide plate 16, which blocks the gap between the LEDs 17 and the liquid crystal panel 11, and therefore, the light-shielding function can be further improved. The light guide plate supporting portion 26b is formed at least in portions of the light-shielding member 26 that are disposed in the non-overlapping sections NLA, or in other words, in positions that overlap the heat dissipation accelerating portion 26c in a plan view, and therefore, the light guide plate supporting portion 26b can press firmly the light guide plate 16 together with the heat dissipation accelerating portions 26c, the frame 13 disposed the display surface 11c side, and the chassis 14. As a result, the light guide plate 16 can be accurately positioned with respect to the LEDs 17. Heat from the LEDs 17 can be transferred not only to the frame 13 disposed on the display surface 11c side, but also to the light guide plate 16, and therefore, the heat-dissipating property can be further improved.

Of the pair of frame 13 and the chassis 14, at least the frame 13 disposed on the display surface 11c side is made of a metal. With this configuration, the frame 13 disposed on the display surface 11c side has excellent heat conductivity, and therefore, heat from the LEDs 17, which is transferred through the heat dissipation accelerating portions 26c, can be dissipated more efficiently. The rigidity of the frame 13 disposed on the display surface 11c side is made higher, which makes this configuration useful when the liquid crystal display device 10 is made larger.

The light-shielding member 26 is disposed so as to extend over an edge of the liquid crystal panel 11 in the entire length thereof. With this configuration, light leakage to the liquid crystal panel 11 can be prevented more reliably.

The light-shielding member 26 has the light guide plate supporting portion 26b that abuts on a surface of the light guide plate 16 that faces the liquid crystal panel 11. In this configuration, the light guide plate supporting portion 26b formed in the light-shielding member 26 abuts on the light guide plate 16, which blocks the gap between the LEDs 17 and the liquid crystal panel 11, and therefore, the light-shielding function can be further improved. Also, by supporting the light guide plate 16 with the light guide plate supporting portion 26b from the liquid crystal panel 11 side, the light guide plate 16 can be positioned with respect to the LEDs 17.

The light guide plate supporting portion 26b abuts on an edge of the light guide plate 16 that faces the LEDs 17. With this configuration, by having the light guide plate supporting portion 26b support an edge of the light guide plate 16 that faces the LEDs 17, a stable positional relationship between the LEDs 17 and the end face of the light guide plate 16 that faces the LEDs 17 can be achieved. As a result, the incident efficiency of light that enters the light guide plate 16 from the LEDs 17 can be made stable.

The display device further includes the LED substrate (light source substrate) 18 on which the LEDs 17 are mounted, and the LED substrate 18 is attached to the heat-dissipating member 19 having the light-shielding member 26. In this configuration, the LED substrate 18 is not provided with the light-shielding member 26, as opposed to a configuration in which the LED substrate is used as the heat-dissipating member (light source attachment member) having the heat-dissipating section, and the light-shielding member 26 is provided in the LED substrate. Therefore, a commonly-available part can be used as the LED substrate 18 instead of a special part. As a result, the cost of the LED substrate 18 can be reduced, and the mounting of the LEDs 17 can be made easier.

The heat-dissipating member 19 has the heat-dissipating section 19b that extends along a plate surface of the chassis 14, of the pair of frame 13 and chassis 14, that is disposed on a side of the display device opposite to the display surface 11c, and the heat-dissipating section 19b makes surface-to-surface contact with the plate surface of the chassis 14 disposed on the side opposite to the display surface 11c. With this configuration, heat can be efficiently transferred to the chassis 14 that is disposed on the side opposite to the display surface 11c from the heat-dissipating section 19b of the heat-dissipating member 19, and therefore, heat is less likely to be trapped in the liquid crystal display device 10.

The heat-dissipating member 19 has the LED attachment section (light source attachment section) 19a to which the LEDs 17 are attached, the LED attachment section 19a facing the light guide plate 16, and the frame 13, of the pair of frame 13 and chassis 14, that is disposed on the display surface 11c has the protruding member 21 that protrudes toward the heat-dissipating section 19b, the protruding member 21 being provided to attach the heat-dissipating section 19b. With this configuration, by attaching the heat-dissipating section 19b to the protruding member 21, the LEDs 17 attached to the LED attachment section 19a can be positioned with respect to the light guide plate 16.

The display device further includes the printed board 23 connected to edges of the flexible substrates 22 on a side opposite to the edges connected to the liquid crystal panel 11, and the substrate housing space BS that is connected to the flexible substrate passages FS and that can house the printed board 23 therein is formed between the protruding member 21 and the LED attachment section 19a. With this configuration, the flexible substrates 22 connected to the liquid crystal panel 11 are made to pass through the flexible substrate passages FS, and are connected to the printed board 23 housed in the substrate housing space BS that is connected to the flexible substrate passages FS.

Of the pair of frame 13 and the chassis 14, at least the chassis 14 disposed on the side opposite to the display surface 11c is made of a metal. With this configuration, the chassis 14 disposed on the side opposite to the display surface 11c has excellent heat conductivity, and therefore, heat from the LEDs 17, which is transferred through the heat dissipation section 19b of the heat-dissipating member 19, can be dissipated more efficiently. The rigidity of the frame 14 disposed on the side opposite to the display surface 11c is made higher, which makes this configuration useful when the liquid crystal display device 10 is made larger.

Embodiment 1 of the present invention has been described above, but the present invention is not limited to the embodiment above, and may include modification examples below, for example. In the modification examples below, components similar to those in the embodiment above are given the same reference characters, and descriptions and depictions thereof may be omitted.

### Modification Example 1 of Embodiment 1

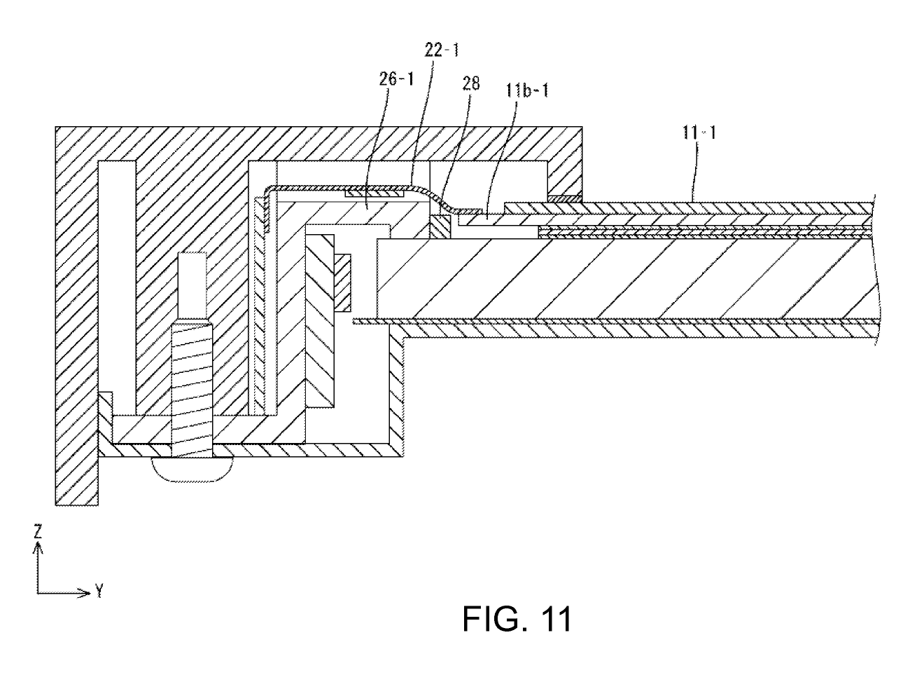

Modification Example 1 of Embodiment 1 will be described with reference to FIG. 11. In this example, the light-shielding member 26-1 is provided with a buffer member 28.

As shown in FIG. 11, the light-shielding member 26-1 of this modification example is provided with a buffer member 28 that is interposed between the light-shielding member 26-1 and the end face of the liquid crystal panel 11-1. The buffer member 28 is bonded to the surface of the light-shielding member 26-1 that faces the liquid crystal panel 11-1 with a bonding member such as an adhesive or double-sided tape. The buffer member 28 is configured to abut on an end face of the array substrate 11b-1 of the liquid crystal panel 11-1, the end face facing the light-shielding member 26-1. This makes it possible to prevent damage and the like caused by the liquid crystal panel 11-1 directly touching the light-shielding member 26-1. It is preferable that the height of the buffer member 28 be set so as not to touch the flexible substrate 22-1, but the buffer member 28 may touch the flexible substrate 22-1.

### Modification Example 2 of Embodiment 1

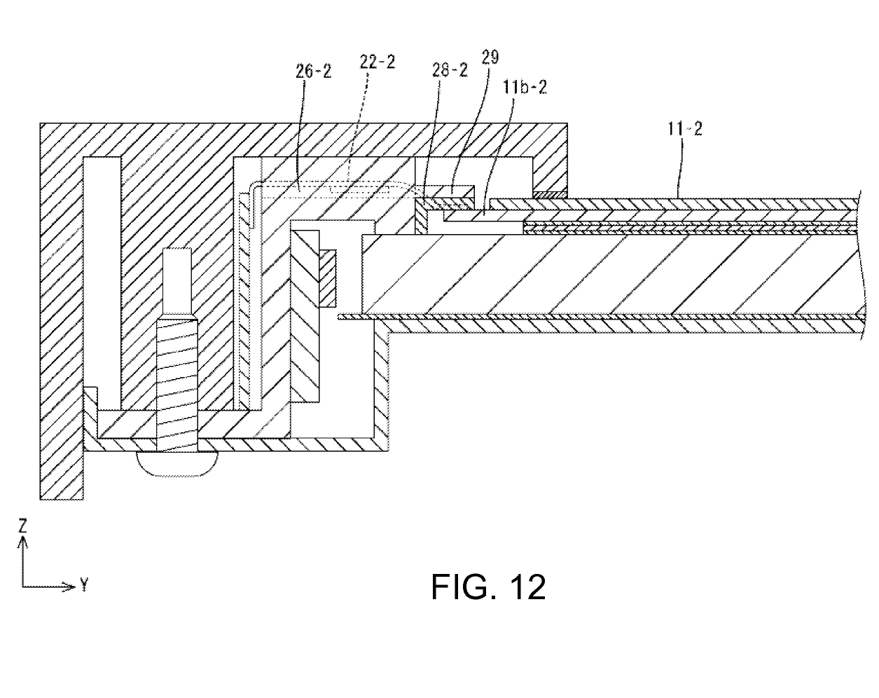

Modification Example 2 of Embodiment 1 will be described with reference to FIG. 12. In this example, Modification Example 1 above is further modified, and the light-shielding member 26-2 is provided with a panel-receiving protrusion 29.

As shown in FIG. 12, the light-shielding member 26-2 of this modification example is provided with the panel-receiving protrusion 29 that receives the liquid crystal panel 11 from the front side. The panel-receiving protrusion 29 protrudes from the inner surface of the light-shielding member 26-2 toward the inside, and faces the array substrate 11b-2 of the liquid crystal panel 11-2 on the front side thereof. The panel-receiving protrusion 29 is disposed only in the non-overlapping section NLA that does not overlap the flexible substrate 22-2 in a plan view, thereby avoiding contact with the flexible substrate 22-2. A buffer member 28-2 is disposed so as to touch both the light-shielding member 26-2 and the surface of the panel-receiving protrusion 29 that faces the liquid crystal panel 11-2, thereby forming an L-shaped cross-section. By the buffer member 28-2 abutting the array substrate 11b-2 at the front surface and the end face that faces the light-shielding member 26-2, the buffer member 28-2 can receive the array substrate 11b-2 while absorbing shock.

### Modification Example 3 of Embodiment 1

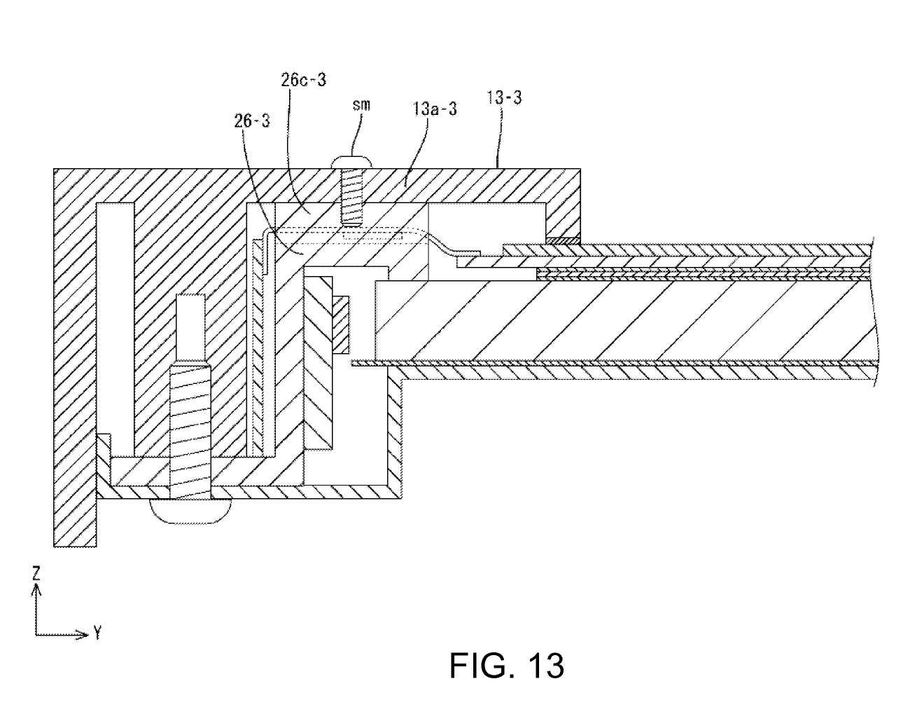

Modification Example 3 of Embodiment 1 will be described with reference to FIG. 13. In this example, a screw sm for fastening the frame 13-3 and the light-shielding member 26-3 to each other is added.

As shown in FIG. 13, the light-shielding member 26-3 of this modification example is affixed to the panel receiving portion 13a-3 of the frame 13-3 by the screw sm. In the light-shielding member 26-3, the heat dissipation accelerating portion 26c-3 that abuts on the panel receiving portion 13a-3, and the panel receiving portion 13a-3 respectively have insertion holes formed therein that are connected to each other, and the screw sm is made pass through these insertion holes from the front side. By the screw sm, the panel receiving portion 13a-3 and the heat dissipation accelerating portion 26c-3 remain in close contact with each other, which further improves the heat dissipating property.

### Embodiment 2

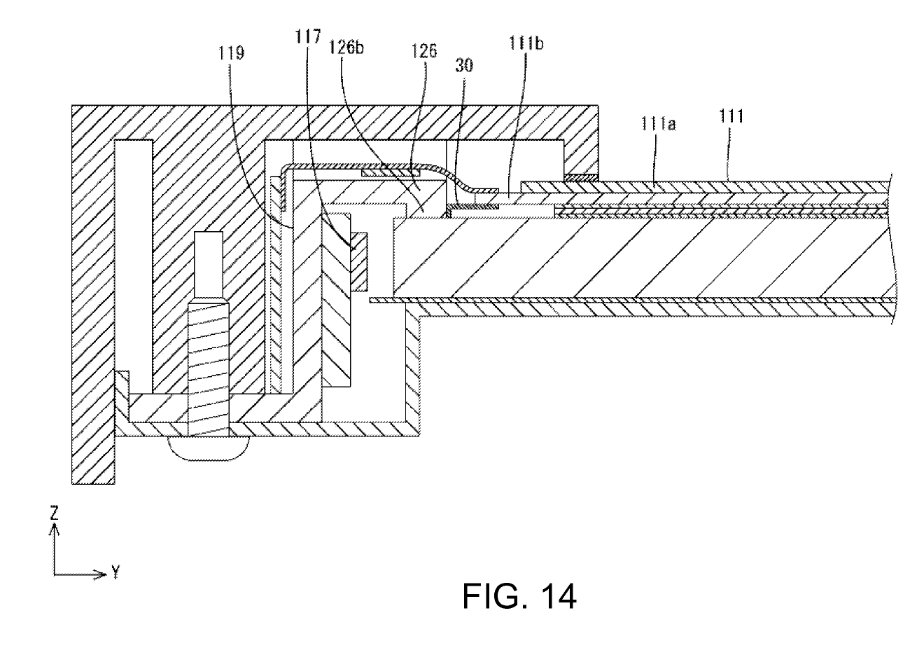

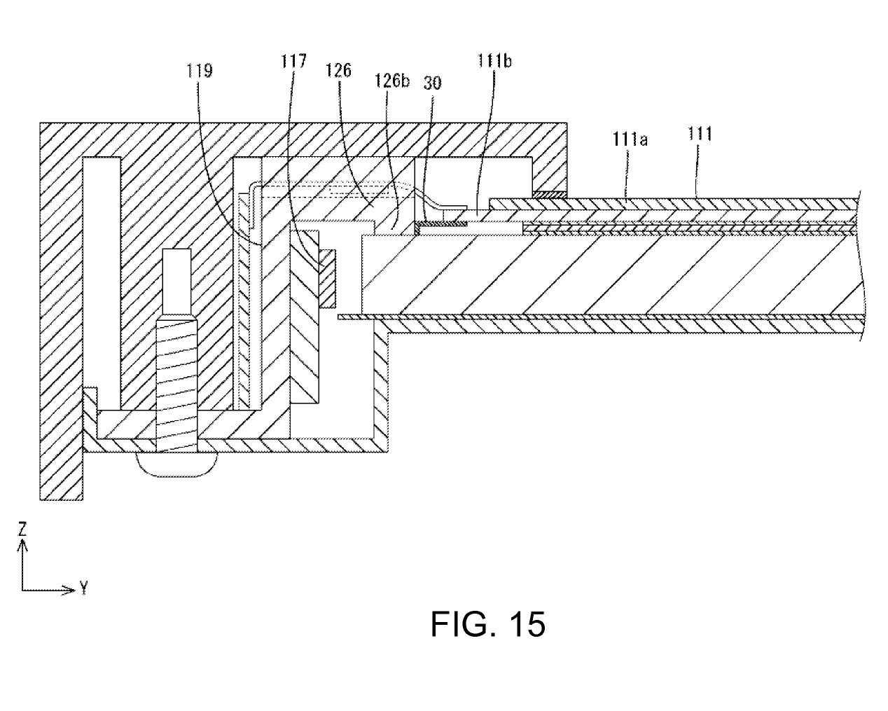

Embodiment 2 of the present invention will be described with reference to FIGS. 14 and 15. In Embodiment 2, a heat-dissipating sheet member 30 that is disposed so as to be continued to the light-shielding member 126 and the liquid crystal panel 111 is added. Descriptions of structures, operations, and effects similar to those of Embodiment 1 will be omitted.

As shown in FIGS. 14 and 15, the light-shielding member 126 and the liquid crystal panel 111 of the present embodiment are thermally connected to each other by the heat-dissipating sheet member 30. The heat-dissipating sheet member 30 has higher heat conductivity than heat conductivity of the metal heat-dissipating member 119 that has the light-shielding member 126, and heat conductivity of respective glass substrates 111a and 111b of the liquid crystal panel 111, and has sufficient flexibility. A graphite sheet that is formed by processing graphite into a sheet shape is used as the heat-dissipating sheet member 30, for example. One end of the heat-dissipating sheet member 30 is bonded to the rear surface of an edge of the array substrate 111b that constitutes a part of the liquid crystal panel 111, the edge facing the light-shielding member 126, and the other end of the heat-dissipating sheet member 30 is bonded to a surface of the light-shielding member 126 (light guide plate supporting portion 126b) that faces the liquid crystal panel 111, respectively, by a bonding member such as an adhesive or double-sided tape. The heat-dissipating sheet member 30 extends along the longer side direction of the light-shielding member 126 and the liquid crystal panel 111, and is formed to cover the entire length thereof (cover the overlapping sections LA and the non-overlapping sections NLA). With this heat-dissipating sheet member 30, heat from the LEDs 117 can be transferred to the liquid crystal panel 111, and therefore, heat can be dissipated more efficiently using the thermal capacity of the liquid crystal panel 111.

As described above, in the present embodiment, the heat-dissipating sheet member 30 disposed so as to be continued to the light-shielding member 126 and the liquid crystal panel 111 is provided. With this configuration, heat emitted from the LEDs 17 due to illumination is first transferred from the LEDs 117 to the heat-dissipating member 119, and then transferred further from the light-shielding member 126 of the heat-dissipating member 119 to the liquid crystal panel 111 via the heat-dissipating sheet member 30. Thus, the heat is efficiently dissipated using the thermal capacity of the liquid crystal panel 111.

### Embodiment 3

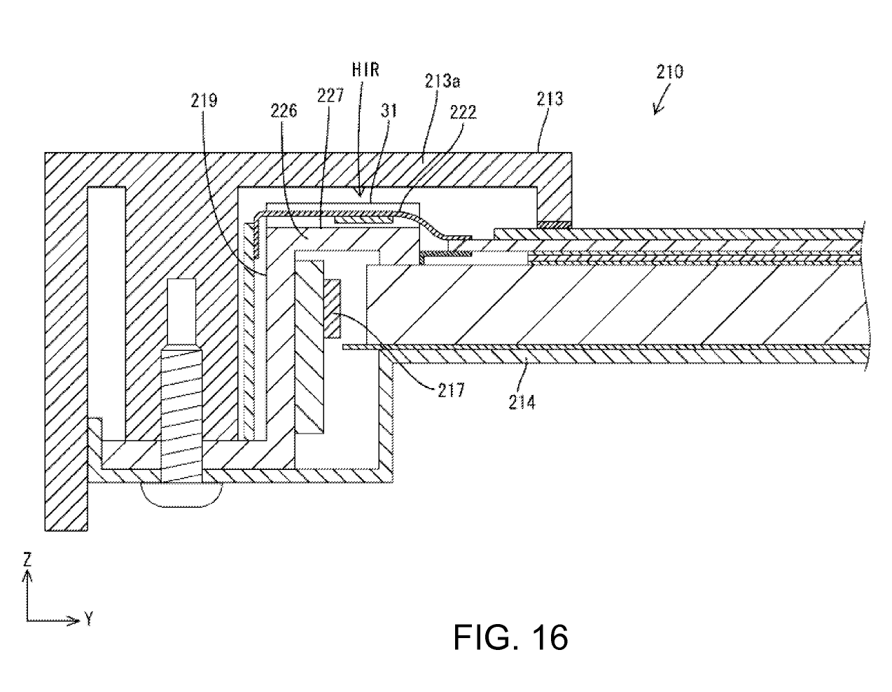

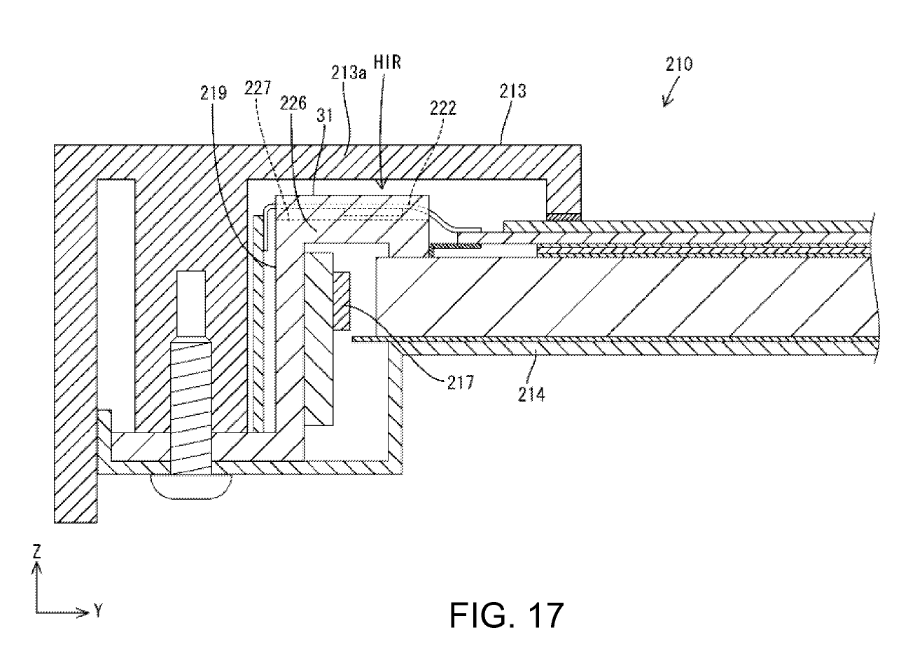

Embodiment 3 of the present invention will be described with reference to FIGS. 16 and 17. In Embodiment 3, the configuration described in Embodiment 2 above is further provided with a heat insulating layer HIR interposed between the light-shielding member 226 and the frame 213. Descriptions of structures, operations, and effects similar to those of Embodiments 1 and 2 will be omitted.

As shown in FIGS. 16 and 17, the light-shielding member 226 of the present embodiment is configured so as not to touch the panel pressing portion 213a of the frame 213, and an air space is formed between the light-shielding member 226 and the panel pressing portion 213a as the heat insulating layer HIR. That is, the light-shielding member 226 of the present embodiment does not have the heat dissipation accelerating portion 26c described in Embodiment 1 above. With this configuration, less heat is transferred from the heat-dissipating member 219 to the frame 213 than in Embodiment 1 above, and an increase in temperature of the frame 213 caused by the heat from the LEDs 217 becomes less likely to occur The frame 213 constitutes the front exterior of the liquid crystal display device 210, or in other words, the exterior on the side that faces viewers, and as compared to the chassis 214 that constitutes the rear exterior, an external object can touch the frame 213 more easily. In the present embodiment, heat generated from the LEDs 217 is less likely to be transferred to the panel pressing portion 213a as a result of the heat insulating layer HR as described above, and the frame 213 is less susceptible to temperature increase caused by the heat from the LEDs 217, and the temperature thereof is kept low. Therefore, even if an external object touches the frame 213, it is possible to effectively prevent the object from being adversely affected by the heat. In particular, the frame 213 of the present embodiment is made of a metal in order to ensure adequate mechanical strength, and therefore has excellent heat conductivity. Thus, by blocking heat transfer from the LEDs 217 with the heat insulating layer HIR, the temperature increase is effectively suppressed. In the light-shielding member 226, flexible substrate passage recesses 227 where the flexible substrates 222 go through are formed in the overlapping sections LA that overlap the flexible substrates 222 in a plan view, and protrusions 31 that protrude toward the front side but do not touch the panel pressing portion 213a are formed in the non-overlapping sections NLA that do not overlap the flexible substrates 222.

### Embodiment 4

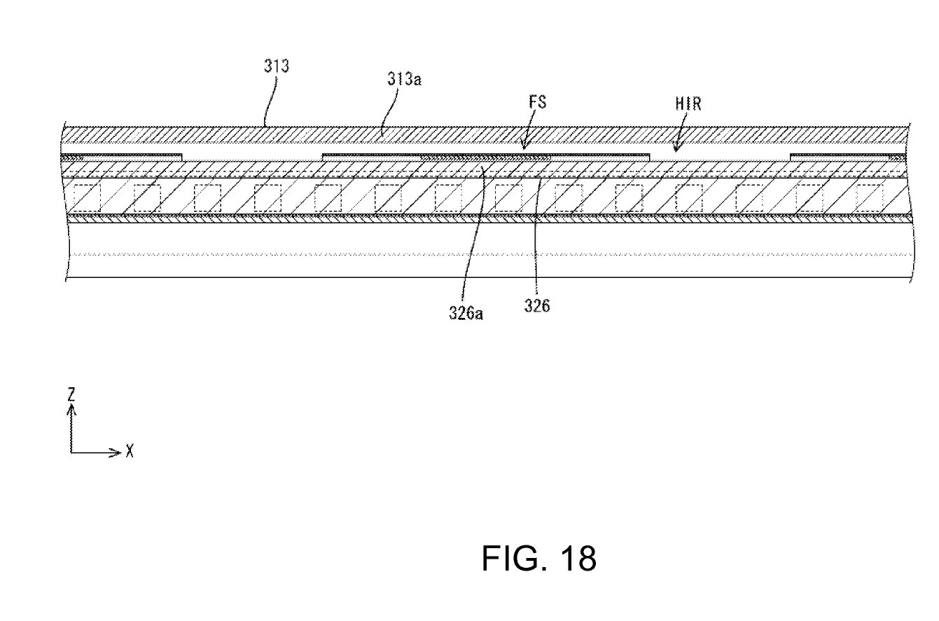

Embodiment 4 of the present invention will be described with reference to FIG. 18. In Embodiment 4, the protrusions 31 are omitted from the configuration described in Embodiment 3 above. Descriptions of structures, operations, and effects similar to those of Embodiment 3 will be omitted.

As shown in FIG. 18. the light-shielding member 326 of the present embodiment does not have the protrusions 31 described in Embodiment 3 above, and the entire front side of the light-shielding base 326a thereof (surface facing the frame 313) has a flat surface. Even with this configuration, the flexible substrate passages FS and the heat insulating layers HIR are respectively formed between the light-shielding base 326a and the panel pressing portion 313a of the frame 313.

### Embodiment 5

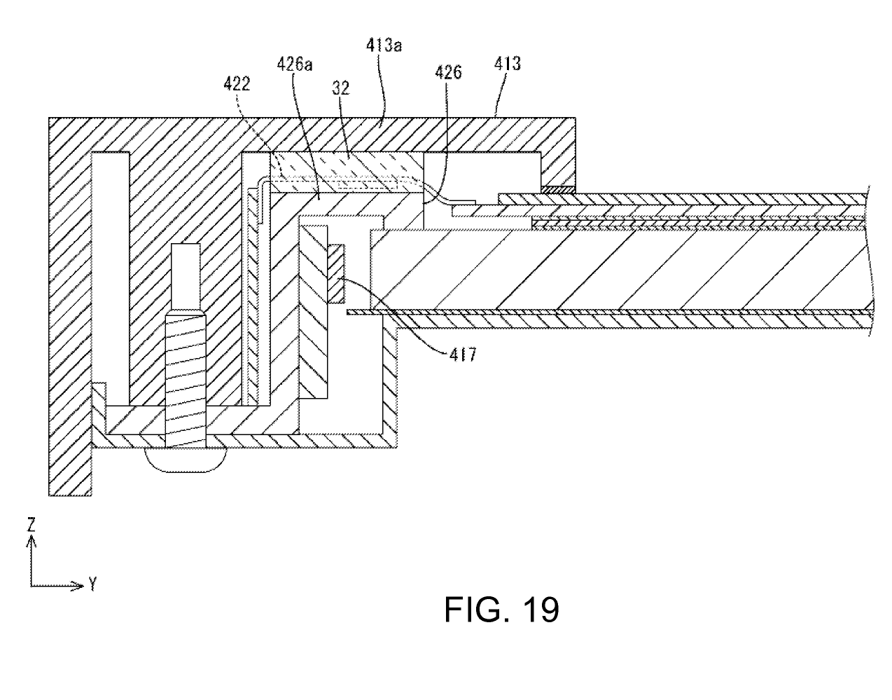

Embodiment 5 of the present invention will be described with reference to FIG. 19. Embodiment 5 is substantially a modification example of Embodiment 4 above, and a heat insulating member 32 is provided as the heat insulating layer HIR, instead of an air space. Descriptions of structures, operations, and effects similar to those of Embodiment 1 will be omitted.

In the present embodiment, between the light-shielding base 426a of the light-shielding member 426 and the panel pressing portion 413a of the frame 413, a heat insulating member 32 having a heat insulating layer HIR is interposed. The heat insulating member 32 is a foam heat insulating member made of a foam resin material (such as foam PET and foam urethane), and by having numerous fine air bubbles (not shown) therein, excellent insulating property is achieved. The numerous air bubbles in the heat insulating member 32 constitute the heat insulating layer HIR. The heat insulating member 32 is entirely bonded to the light-shielding member 426 using a bonding material such as an adhesive or a double-sided tape. The heat insulating member 32 makes surface-to-surface contact with the light-shielding base 426a and the panel pressing portion 413a, thereby blocking the heat passage therebetween. The heat insulating member 32 is disposed only in non-overlapping sections NLA that do not overlap flexible substrates 422 in the light-shielding member 426, and not disposed in overlapping sections LA that overlap the flexible substrates 422. With this configuration, the heat insulating member 32 is prevented from touching the flexible substrates 422. As described above, by blocking the heat transfer between the light-shielding member 426 and the frame 413 by the heat insulating member 32, heat from LEDs 417 is less likely to be transferred to the frame 413, and an increase in temperature of the frame 413 can be appropriately suppressed. In the present embodiment, the heat-dissipating sheet member 30 described in Embodiments 2 and 3 is omitted.

### Embodiment 6

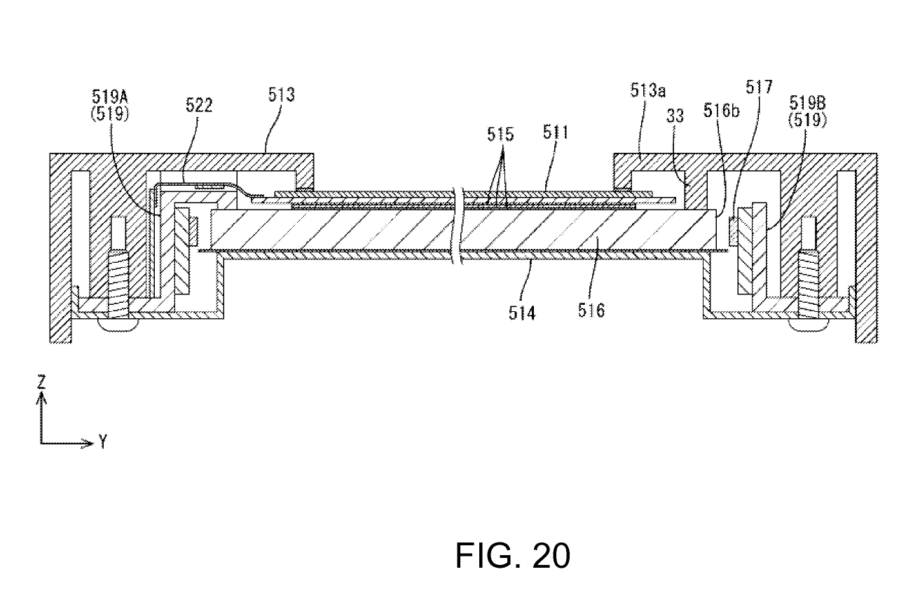

Embodiment 6 of the present invention will be described with reference to FIG. 20. In Embodiment 6, the light-shielding member 26 is removed from a heat-dissipating member 519B located in a position that does not overlap flexible substrates 522 in a plan view, and instead, a frame 513 is provided with a light-shielding member 33. Descriptions of structures, operations, and effects similar to those of Embodiment 1 will be omitted.

As shown in FIG. 20, of a pair of heat-dissipating members 519 of the present embodiment, the heat-dissipating member 519B located in a position that does not overlap the flexible substrates 522 in a plan view is not provided with the light-shielding member 26 described in Embodiment 1 above. Instead of the light-shielding member 26, a light-shielding member 33 is integrally formed with a panel pressing portion 513a of the frame 513 in a longer side portion thereof located in a position that does not overlap the flexible substrates 522 in a plan view (located on a side opposite to the side where the flexible substrates 522 are disposed). The light-shielding member 33 is interposed between a liquid crystal panel 511 and LEDs 517. The light-shielding member 33 protrudes from the panel pressing portion 513a toward the rear side, and is formed in a substantially block shape that is horizontally long and that extends along the longer side direction (X axis direction). By blocking a space between the LEDs 517 and the respective end faces of the liquid crystal panel 511 and optical members 515 that face the LEDs 517, the light-shielding member 33 prevents light from the LEDs 517 from directly entering the respective end faces of the liquid crystal panel 511 and the optical members 515 without passing through a light guide plate 516. That is, the light-shielding member 33 has a so-called light-shielding function. The light-shielding member 33 is configured such that the protrusion end face thereof makes contact with a portion of the light guide plate 516 that protrudes beyond the liquid crystal panel 511 and the optical members 515 toward the LEDs 517 (edge portion that has a light-receiving surface 516b). Therefore, the light-shielding member 33 can support the light guide plate 516 by pressing the light guide plate 516 with a chassis 514, thereby accurately positioning the light guide plate 516 to the LEDs 517 with respect to the Z axis direction. The light-shielding member 33 abuts on the light guide plate 516 over the entire length thereof in the longer side direction. A heat-dissipating member 519A located in a position that overlaps the flexible substrates 522 in a plan view has the same configuration as that described in Embodiment 1 above.

### Embodiment 7

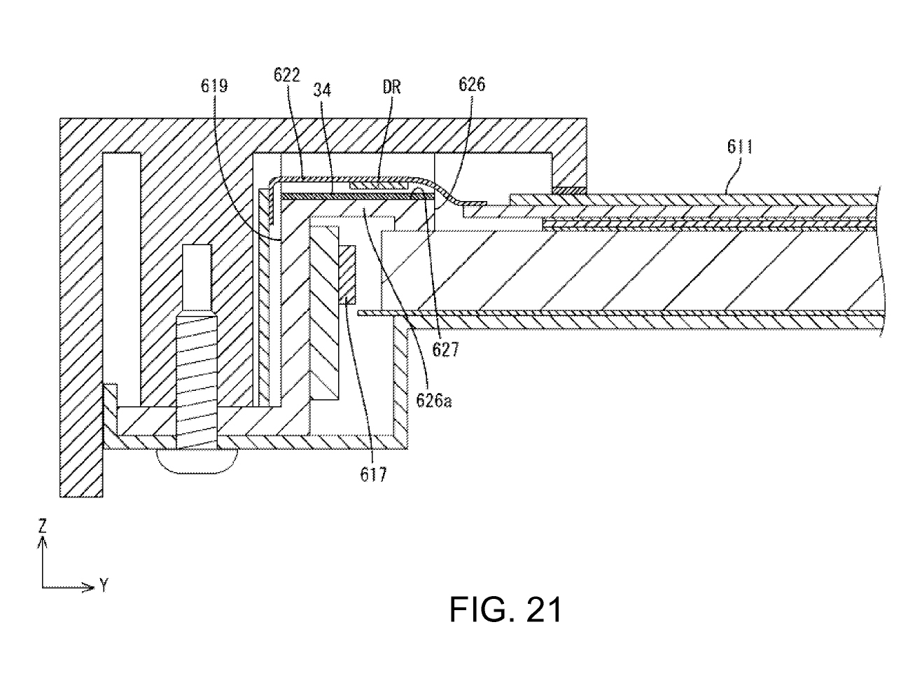

Embodiment 7 of the present invention will be described with reference to FIG. 21. In Embodiment 7, an insulating member 34 is provided on a surface of a light-shielding member 626 that faces flexible substrates 622. Descriptions of structures, operations, and effects similar to those of Embodiment 1 will be omitted.

As shown in FIG. 21, the light-shielding member 626 of the heat-dissipating member 619 of the present embodiment is provided with the insulating member 34 in the overlapping sections LA that overlap the flexible substrates 622 in a plan view. The insulating member 34 is interposed between the light-shielding member 626 and the flexible substrates 622. The insulating member 34 is attached to the front surface of a light-shielding base 626a of the light-shielding member 626, or in other words, a surface thereof that faces the surfaces of the flexible substrates 622. The insulating member 34 has a band-shaped (tape-shaped) or sheet-shaped base member made of a synthetic resin having excellent insulating property, and by having a bonding layer (not shown) on the surface of the base member that faces the light-shielding base 626a, the insulating member 34 is bonded to the light-shielding base 626a. The insulating member 34 is formed over the entire length of the light-shielding base 626a in the Y axis direction (direction in which the flexible substrates 622 extend). The X axis dimension (width dimension) of the insulating member 34 is at least substantially the same as the X axis dimension of the driver DR mounted on the flexible substrate 622, but it is preferable to be made larger than the X axis dimension of the driver DR, and it is more preferable to be substantially the same as the X axis dimension of the flexible substrate 622 (flexible substrate passage recess 627). The insulating member 34 is disposed on the bottom surface of the flexible substrate passage recess 627 in the light-shielding member 626.

As described above, the insulating member 34 provided in the light-shielding member 626 can prevent the driver DR mounted on the flexible substrate 622 from directly touching the light-shielding member 626 in the heat-dissipating member 619 made of a metal. This makes it possible to prevent short-circuit between the driver DR and the heat-dissipating member 619 made of a metal, and also to prevent an increase in temperature of the driver DR by suppressing the heat transfer to the driver DR from the heat-dissipating member 619, to which heat from the LEDs 617 is transferred. By preventing short-circuit and temperature increase of the driver DR, malfunction of the driver DR can be prevented, and effects such as the liquid crystal panel 611 being less susceptible to display defects can be achieved.

### Other Embodiments

The present invention is not limited to the embodiments shown in the drawings and described above, and the following embodiments are also included in the technical scope of the present invention, for example.

(1) In the respective embodiments above, the configuration in which the heat-dissipating member located in a position that overlaps the flexible substrates in a plan view, and the heat-dissipating member located in a position that does not overlap the flexible substrates have different structures (in Embodiment 1, for example, one of the heat-dissipating members had the flexible substrate passage recesses, and the other did not have the flexible substrate passage recesses). It is, however, also possible to make the heat-dissipating member that is located in a position that overlaps the flexible substrates in a plan view (the heat-dissipating member having the flexible substrate passage recesses in Embodiment 1, for example) a common part that is also be used as the heat-dissipating member located in a position that does not overlap the flexible substrates. With this configuration, the number of types of heat-dissipating members can be reduced, which makes this configuration preferable in order to lower the manufacturing cost.

(2) In the respective embodiments above, the light-shielding member extends over the overlapping sections that overlap the flexible substrates and the non-overlapping sections that do not overlap the flexible substrates, but the present invention also includes a configuration in which the light-shielding members are selectively disposed in the overlapping sections only, and not in the non-overlapping sections.

(3) In the respective embodiments above, the light-shielding member is disposed over all of the plurality of overlapping sections that overlap the flexible substrates and all of the plurality of non-overlapping sections that do not overlap the flexible substrates, but the present invention also includes a configuration in which the light-shielding member is disposed only in some of the plurality of overlapping sections, or in which the light-shielding member is disposed only in some of the plurality of non-overlapping sections.

(4) In the respective embodiments above, the light-shielding member extends over the entire length of the edge of the liquid crystal panel, but the present invention also includes a configuration in which the light-shielding member faces a part of the edge of the liquid crystal panel, for example. In such a case, the number of light-shielding member may be one or more.

(5) In the respective embodiments above, the light guide supporting section extends over the entire length of the edge of the light guide plate, but the present invention also includes a configuration in which the light guide plate supporting portion faces a part of the edge of the light guide plate, for example. In such a case, the number of light guide plate supporting portion may be one or more.

(6) In the respective embodiments above, the light guide plate supporting portion abuts on the edge of the light guide plate, but the present invention also includes a configuration in which the light guide plate supporting portion abuts on a portion of the light guide plate that is located inside of the edge thereof.

(7) It is apparent that the technical matter described in the respective modification examples of Embodiment 1 above can be applied to the configurations described in Embodiments 2 to 7.

(8) In Embodiment 2 above, a graphite sheet was used as the heat-dissipating sheet member, but as long as the sheet member has excellent heat conductivity, another type of heat dissipating sheet may be used.

(9) In Embodiment 3, the heat-dissipating sheet member was used in the configuration in which the heat insulating layer is interposed between the light-shielding member and the frame, but depending on the thermal design, the heat-dissipating sheet member may be omitted.

(10) Embodiment 5 above showed the configuration in which the heat-dissipating sheet member was omitted from the configuration in which the heat insulating member is interposed between the light-shielding member and the frame, but depending on the thermal design, the heat-dissipating sheet member described in Embodiments 2 and 3 may be added.

(11) In Embodiment 5 above, the heat insulating member was made of a foam resin material, but the present invention also includes a configuration in which the heat insulating member is made of a foam rubber material.

(12) In the respective embodiments above, the protruding members were formed integrally with the frame, but the present invention also includes a configuration in which the protruding members are separate parts from the frame, and are attached to the frame. In such a case, the protruding members may be made of a metal as in the frame, or may be made of a synthetic resin that is a different material from that of the frame.

(13) In the respective embodiments above, the light-shielding member was integrally formed with the heat-dissipating member to which the LED substrate having LEDs mounted thereon is attached, but the present invention also includes a configuration in which the heat-dissipating member is omitted, the LED substrate is attached to the protruding member, and the light-shielding member is integrally formed with the LED substrate. In such a case, the LED substrate needs to have the substantially L-shaped cross-section as in the heat dissipating member, and needs to be constituted of an LED mounting section in which the LEDs are mounted, and a heat dissipating section that makes surface-to-surface contact with the plate surface of the chassis.

(14) In the respective embodiments above, the heat dissipating section of the heat dissipating member protruded from the LED attachment section in a direction opposite to the light guide plate, but the present invention also includes a configuration in which the heat dissipating section protrudes from the LED attachment section toward the light guide plate.

(15) In the respective embodiments above, the flexible substrates were connected only to one longer side edge of the liquid crystal panel, but the present invention can also be applied to a configuration in which the flexible substrates are respectively connected to two longer side edges of the liquid crystal panel.

(16) In addition to (15) above, the present invention can be applied to a configuration in which the flexible substrates are connected only to one shorter side edge of the liquid crystal panel, a configuration in which the flexible substrates are respectively connected to two shorter side edges, a configuration in which the flexible substrates are connected to three side edges of the liquid crystal panel, and a configuration in which the flexible substrates are connected to the respective four side edges of the liquid crystal panel.

(17) In addition to the respective embodiments above, the number, arrangement, arrangement pitch, and the like of the flexible substrates in the liquid crystal panel may be appropriately changed.

(18) In the respective embodiments above, a pair of LED units (heat-dissipating members, LED substrates) was disposed at the respective longer side edges of the light guide plate so as to face each other, but the present invention also includes a configuration in which the pair of LED units is disposed at the respective shorter side edges of the light guide plate so as to face each other, for example.

(19) In addition to (18) above, the present invention includes a configuration in which two pairs of LED units (heat-dissipating members, LED substrates), that is, total of four LED units, are disposed at the respective longer side edges and shorter side edges of the light guide plate so as to face each other, and a configuration in which one LED unit is disposed at one longer side edge or one shorter side edge of the light guide plate. The present invention also includes a configuration in which three LED units are disposed at three side edges of the light guide plate so as to face each other.

(20) In the respective embodiments above, one LED unit (heat dissipating members, LED substrates) was provided at one side of the light guide plate, but it is also possible to provide a plurality of (two or more) LED units at one side of the light guide plate. In such a case, it is preferable that the plurality of LED units be arranged along the side of the light guide plate.

(21) In the respective embodiments above, the frame and the chassis were exterior members that constitute the exterior of the liquid crystal display device, but the present invention also includes a configuration in which a separately provided exterior part is attached to the rear side of the chassis so as to cover the chassis, for example, so that the chassis is not exposed to the outside. In addition, the present invention includes a configuration in which both the frame and chassis are covered by separately provided exterior parts, so that neither the frame nor the chassis is exposed to the outside.

(22) In the respective embodiments above, the frame and the chassis constituting the exterior member were both made of a metal, but the present invention also includes a configuration in which one or both of the frame and the chassis are made of a synthetic resin. It is preferable to employ this configuration in a mid- to small-sized model that does not require the liquid crystal display device to have very high mechanical strength.

(23) In the respective embodiments above, the chassis and the heat dissipating member were jointly fastened to the protruding member by the screw, but the present invention also includes a configuration in which a screw for affixing the chassis to the protruding member, and a screw for affixing the heat dissipating member to the protruding member are separately provided.

(24) The present invention also includes a configuration in which the screw for affixing the chassis to the protruding member is omitted from the configuration of (23) above, and a locking mechanism that engages the outer wall and the housing portion side wall of the chassis, for example, is provided.

(25) In the respective embodiments above, the screw was used to affix the chassis and the heat dissipating member to the protruding member, but a clip made of a synthetic resin, for example, may also be used, and the chassis and the heat dissipating member may be fastened by having the clip engage the protruding member.

(26) In the respective embodiments above, the power supply board was provided with the function of powering the LEDs, but the present invention also includes a configuration in which an LED driver board that powers the LEDs is separated from the power supply board.

(27) In the respective embodiments above, the main board was provided with a tuner part, but the present invention also includes a configuration in which a tuner board that has a tuner part is separated from the main board.

(28) In the respective embodiments above, the colored portions of the color filters provided in the liquid crystal panel included the three colors of R, G, and B, but it is possible to have the colored portions include four or more colors.

(29) In the respective embodiments above, LEDs were used as the light source, but other types of light source such as an organic EL may also be used.

(30) In the respective embodiments above, TFTs were used as switching elements for the liquid crystal display device, but the present invention can also be applied to a liquid crystal display device using other types of switching elements than TFTs (such as thin-film diodes (TFD), for example), and in addition to a color liquid crystal display device, the present invention can be applied to a liquid crystal display device that conducts black and white display.

(31) In the respective embodiments above, a liquid crystal display device using a liquid crystal panel as a display panel was described as an example, but the present invention can be applied to a display device that uses another type of display panel.

(32) In the respective embodiments above, a television receiver that includes a tuner part was illustratively shown, but the present invention is also applicable to a display device without a tuner part.

(33) In Embodiment 7 above, the insulating member was disposed at the bottom surface (surface that faces the driver) of the flexible substrate passage recess, but the insulating member may also be disposed on one or both of the side faces of the flexible substrate passage recess in addition to the bottom surface thereof, and the present invention also includes such a configuration.

(34) As a modification example of the insulating member described in Embodiment 7 above, the bonding layer may be removed from the base member, and the insulating member may be attached to the light-shielding member by a separately prepared adhesive or double-sided tape. The length dimension (X axis dimension) of the insulating member may be shorter than the length dimension of the light-shielding member, for example. The width dimension (Y axis dimension) of the insulating member may be smaller than the dimension of the driver, for example.

### DESCRIPTION OF REFERENCE CHARACTERS

10, 210, 610 liquid crystal display device (display device)
11, 111, 611 liquid crystal panel (display panel)
11c display surface
13, 213, 313, 413, 513 frame (holding part)
13a, 213a, 313a, 513a panel pressing portion
14, 214, 514 chassis (holding part)
16, 516 light guide plate
17, 117, 217, 417, 517, 617 LED (light source)
18 LED substrate (light source substrate)
19, 119, 219, 519, 619 heat dissipating member (light source attachment member)
19a LED attachment section (light source attachment section)
19b heat-dissipating section
21 protruding member
22, 222, 422, 522, 622 flexible substrate
23 printed board
26, 126, 226, 326, 426, 626 light-shielding member
26b, 126b light guide plate supporting portion
26c heat dissipation accelerating portion
32 heat-dissipating sheet member
BS substrate housing space
FS flexible substrate passage
HM holding member
LA overlapping section
NLA non-overlapping section
TV television receiver

1. A display device, comprising:
a light source;
a light source attachment member to which the light source is attached;
a display panel that conducts display using light from the light source;
a flexible substrate that is connected to an edge of the display panel;
a light guide plate laid on a side of the display panel opposite to a display surface thereof, the light guide plate being disposed such that an end face thereof faces the light source;
a holding member that is constituted of a pair of holding parts that sandwich the display panel and the light guide plate from a display surface side of the display device and a side opposite thereto, the holding member housing the light source, the light source attachment member, and the flexible substrate between said pair of holding parts; and
a light-shielding member provided in the light source attachment member, the light-shielding member being interposed between the display panel and the light source so as to block light from the light source from directly entering the display panel, the light-shielding member being configured such that a flexible substrate passage through which the flexible substrate passes is formed between the light-shielding member and said holding part that is disposed on the display surface side.

2. The display device according to claim 1,
wherein a plurality of said flexible substrates are arranged at intervals in a direction along the edge of the display panel, and
wherein the light-shielding member is disposed so as to extend in the direction along the edge of the display panel across an overlapping section that overlaps the flexible substrate in a plan view and a non-overlapping section that does not overlap the flexible substrate in a plan view.

3. The display device according to claim 2,
wherein the light-shielding member has a heat dissipation accelerating portion in a part thereof that is disposed in the non-overlapping section, the heat-dissipation accelerating portion abutting on said holding part that is disposed on the display surface side.

4. The display device according to claim 3,
wherein the light-shielding member has a light guide plate supporting portion at least in a part thereof that is disposed in the non-overlapping section, the light guide plate supporting portion abutting on a surface of the light guide plate that faces the display panel.

5. The display device according to claim 3,
wherein at least said holding part that is disposed on the display surface side is made of a metal.

6. The display device according claim 2,
wherein the light-shielding member is disposed so as to extend over the edge of the display panel in an entire length thereof.

7. The display device according claim 1,
wherein the light-shielding member has a light guide plate supporting portion that abuts on a surface of the light guide plate that faces the display panel.

8. The display device according to claim 7,
wherein the light guide plate supporting portion abuts on an edge of the light guide plate, said edge facing the light source.

9. The display device according claim 1, further comprising a light source substrate on which the light source is mounted,
wherein the light source substrate is attached to the light source attachment member having the light-shielding member.

10. The display device according claim 1,
wherein the light source attachment member has a heat-dissipating section that extends along a plate surface of said holding part that is disposed on a side of the display device opposite to the display surface side, the heat-dissipating section making surface-to-surface contact with the plate surface of said holding part disposed on the side opposite to the display surface side.

11. The display device according to claim 10,
wherein the light source attachment member has a light source attachment section to which the light source is attached, the light source attachment section facing the light guide plate, and
wherein said holding part that is disposed on the display surface side has a protruding member that protrudes toward the heat-dissipating section, the protruding member allowing the heat-dissipating section to be attached thereto.

12. The display device according to claim 11, further comprising a printed board connected to an edge of the flexible substrate opposite to the edge connected to the display panel,
wherein a substrate housing space that is connected to the flexible substrate passage and that can house the printed board therein is formed between the protruding member and the light source attachment section.

13. The display device according to claim 10,
wherein at least said holding part that is disposed on the side opposite to the display surface side is made of a metal.

14. The display device according to claim 1, further comprising a heat-dissipating sheet member disposed so as to be continued to the light-shielding member and the display panel.

15. A television receiver, comprising the display device according to claim 1.
